(19) United States
(12) Patent Application Publication
(10) Pub. No.: US 2010/0269521 A1
(43) Pub. Date: Oct. 28, 2010

(54) AIR-CONDITIONING WITH DEHUMIDIFICATION

(76) Inventor: Steven Clay Moore, Austin, TX (US)

Correspondence Address: Schubert Law Group PLLC, 6013 CANNON MOUNTAIN DRIVE, S14, AUSTIN, TX, 78749, US

(21) Appl. No.: 12/546,684

(22) Filed: Aug. 25, 2009

Related U.S. Application Data
(60) Provisional application No. 61/173,203, filed on Apr. 28, 2009.

(51) Int. Cl. F25D 17/06; F28F 13/00; F28F 9/02; F28F 1/36; F25B 39/02; B23P 15/26; F25B 1/00; G05B 15/00; F25D 23/00

(52) U.S. Cl. 62/91; 165/133; 165/175; 165/184; 62/524; 29/890.035; 62/498; 62/428; 700/276; 62/259.4

(57) ABSTRACT

One embodiment comprises an apparatus with an evaporative unit for a refrigerant having a flow direction opposing the airflow direction and an adjustable airflow rate to utilize to produce both cold/dehumidified exit air and warmed exit refrigerant for high efficiency and to maintain an airflow sufficient to avoid freeze-up of evaporative unit or freeze-up to an extent that blocks the airflow. This may produce low humidity even when the room thermostat is set warm (e.g. 85 F) and 5%-30% lower A/C bills. Other embodiments comprise systems and methods related to the adjustable airflow. A further embodiment comprises a controller to adjust the humidity in an air-conditioned space to produce air, which is both temperature and humidity controlled.

### BACKGROUND

The present invention is in the field of air conditioners (A/Cs), and more specifically in the field of evaporator coils which achieve more air dehumidification.

Standard A/C units are not designed to produce the lowest easily achievable humidity because when indoor space is cooled to the typical desired temperature, 70-72 degrees Fahrenheit (° F.), dehumidification is sufficient and indeed, at the normal temperature in air conditioned space, lower humidity would be undesirable because the combination of low humidity and 72° F. temperature air would make most people feel uncomfortably cold. Typical air conditioner coils rely on a relatively large volume of airflow through a large but relatively thin coil to exchange heat from the Freon, R-22 or other refrigerant, as it boils inside the coil tubing, to the air passing through the coil fins.

Standard evaporator coils use flow patterns such that the refrigerant flows through the coil perpendicularly to air. Since the vast majority of cooling is provided by the boiling of the refrigerant, a coil design which maximizes the contact area between incoming air and coils with boiling Freon inside provides an efficient transfer of cold from the refrigerant to the air, but does not dehumidify adequately when the thermostat is set at higher than normal comfort-level temperature.

To meet requirements for greater Seasonal Energy Efficiency Ratio (“SEER”) efficiency, coil designers have increased the airflow rate and coil size (not its thickness) to assure transfer of all available cooling from the refrigerant to the air. The unfortunate consequence is that humidity may be even higher with higher SEER units, and because low income apartment renters, in order to save money, often set their thermostat at 80-85 Fahrenheit, it is difficult, at such high temperatures, to maintain sufficiently low humidity to prevent mold growth in the most humid parts of the apartment.

The Seasonal Energy Efficiency Ratio (SEER) rating is the BTU of cooling output during its normal annual usage divided by the total electric energy input in watt-hours (W·h) during the same period. A common misconception is that the SEER rating system also applies to heating systems. However, SEER ratings only apply to air-conditioning.

SEER=BTU÷W·h

For example, a 5000 BTU/h air-conditioning unit, with a SEER of 10, operating for a total of 1000 hours during an annual cooling season (i.e., 8 hours per day for 125 days) would provide an annual total cooling output of:

5000 BTU/h×1000 h=5,000,000 BTU

which, for a SEER of 10, would be an annual electrical energy usage of:

5,000,000 BTU÷10=500,000 W·h

and that is equivalent to an average power usage during the cooling season of:

500,000 W·h÷1000 h=500 W

SEER is related to the coefficient of performance (COP) commonly used in thermodynamics and also to the Energy Efficiency Ratio (EER). The EER is the efficiency rating for the equipment at a particular pair of external and internal temperatures, while SEER is calculated over a whole range of external temperatures (i.e., the temperature distribution for the geographical location of the SEER test). SEER is unusual in that it is composed of an Imperial unit divided by an SI unit. The COP is a ratio with the same metric units of energy (joules) in both the numerator and denominator. They cancel out, leaving a dimensionless quantity. Formulas for the approximate conversion between SEER and EER or COP are available from the Pacific Gas and Electric Company: [6] [dead link]

SEER=EER÷0.9 (1)

SEER=COP×3.792 (2)

EER=COP×3.413 (3)

From equation (2) above, a SEER of 13 is equivalent to a COP of 3.43, which means that 3.43 units of heat energy are pumped per unit of work energy.

Today, it is rare to see systems rated below SEER 9 in the United States, since older units are being replaced with higher-efficiency units. The United States now requires that residential systems manufactured in 2006 have a minimum SEER rating of 13 (although window-box systems are exempt from this law, so their SEER is still around 10). [7] Substantial energy savings can be obtained from more efficient systems. For example by upgrading from SEER 9 to SEER 13, the power consumption is reduced by 30% (equal to 1 9/13). It is claimed that this can result in an energy savings valued at up to US $300 per year (depending on the usage rate and the cost of electricity). In many cases, the lifetime energy savings are likely to surpass the higher initial cost of a high-efficiency unit.

As an example, the annual cost of electric power consumed by a 72,000 BTU/h air-conditioning unit operating for 1000 hours per year with a SEER rating of 10 and a power cost of $0.08 per kilowatt hour (kW·h) may be calculated as follows:

unit size,BTU/h×hours per year,h×power cost,$/kW·h÷(SEER,BTU/W·h×1000 W/kW)(72,000 BTU/h)×(1000 h)×($0.08/kW·h)[(10 BTU/W·h)×(1000 W/kW)]=$576.00 annual cost

The amount of cooling energy generally required by an A/C is equal the amount of cooling required to remove the heat produced in the air conditioned space by people, appliances etc., plus an amount of cooling required to balance the heat flow into the space through the space enclosure (walls, windows, ceiling floor etc.) plus heat carried in with infiltrating air. Heat inflow is typically far greater than internally generated heat, especially in older residential buildings. This heat inflow is roughly proportional to the temperature difference between inside and outside the building. And due to the fact that an apartment resident or office occupant will feel equally comfortable at a higher temperature setting if the humidity is lower; reducing humidity in an air conditioned space will save heat inflow related energy costs.

In a normal A/C, the fan speed is constant and must be high enough to cover all expected operating conditions. The highest air speed is required when the coil has become somewhat dirty but it is even more when cooling to a relatively low room temperature.

Refrigeration air-conditioning equipment, the typical household or office A/C, reduces the humidity of the air processed by cooling the inside are below the dew point. The colder the air is cooled, as it passes through the A/C coils, the greater the moisture removal and lower the indoor humidity at a given indoor temperature. As anyone who has been in both the desert and tropics knows, it doesn't feel as hot when the humidity is low. Our tests in actual lived-in apartments show that at 40% relative humidity (RH) a temperature of 80-85° F. feels as comfortable as 72° F. at 65% RH.

A specific type of air conditioner that is used only for dehumidifying is called a dehumidifier. A dehumidifier is different from a regular air conditioner in that both the evaporator and condenser coils are placed in the same air path, and the entire unit is placed in the environment that is intended to be conditioned (in this case dehumidified), rather than requiring the condenser coil to be outdoors. Having the condenser coil in the same air path as the evaporator coil produces warm, dehumidified air. The evaporator (cold) coil is placed first in the air path, dehumidifying the air exactly as a regular air conditioner does. The air next passes over the condenser coil re-warming the now dehumidified air. Note that the terms “condenser coil” and “evaporator coil” do not refer to the behavior of water in the air as it passes over each coil; instead they refer to the phases of the refrigeration cycle. Having the condenser coil in the main air path rather than in a separate, outdoor air path (as in a regular air conditioner) results in two consequences—the output air is warm rather than cold, and the unit is able to be placed anywhere in the environment to be conditioned, without a need to have the condenser outdoors.

Unlike a regular air conditioner, a dehumidifier will actually heat a room. The amount of heating is the same as an electric heater of the same wattage. A regular air conditioner transfers energy out of the room by means of the hot condenser coil, which is outside the air-conditioned space (e.g., outdoors).

### SUMMARY

Some embodiments may comprise a heat exchange unit for an air-conditioning system, comprising tubes with projections to increase surface for exchange of thermal energy from a refrigerant inside the tubes to air passing outside the surfaces of the heat exchange device a distribution line coupled with the tubes at a first end to distribute the refrigerant to the tubes; an inlet coupling coupled with the distribution line to receive the refrigerant; a collection line coupled with the tubes at a second end to receive the refrigerant after the refrigerant passes through the tubes; an outlet coupling coupled with the collection line to output the refrigerant; and connections to couple the heat exchange unit with an incoming airflow and an outgoing airflow.

Such embodiments may comprise the heat exchange unit, wherein heat exchange unit is designed to create airflow in a direction, which is substantially the opposite direction of the flow direction of the refrigerant based upon the difference in temperature between the refrigerant at the first end and the second end of the heat exchange unit.

Such embodiments may comprise the heat exchange unit, wherein the tubes are physically designed to accommodate the airflow about ice while the ice accumulates on the tubes.

Some embodiments may comprise an indoor unit for an air-conditioning system, comprising: a cabinet to receive an input airflow and to output a conditioned airflow, the cabinet comprising: a hollow plate comprising an inlet coupling on one end of the hollow plate and an outlet coupling on an opposite end of the hollow plate, the inlet coupling to couple with an expansion valve to receive the refrigerant to flow within the hollow plate and the outlet coupling to couple with an outgoing line to return the refrigerant to a compressor after the refrigerant passes through the hollow plate; and connections to couple the indoor unit with an incoming airflow and an outgoing airflow designed to create airflow in a direction that is substantially the opposite direction of the flow direction of the refrigerant in the hollow plate.

Such embodiments may comprise the indoor unit, further comprising an expansion valve coupled with the inlet coupling of the hollow plate via a line.

Some embodiments may comprise an evaporative unit for an air-conditioning system, comprising: a set of coils, each coil of the set comprising a medium to transport a refrigerant in one general direction from a first end of the coil to the second end of the coil, the first end of each coil being at a first end of the set of coils and the second end of each coil being at a second end of the set of coils, the medium to conduct heat from an outside of the medium to the refrigerant; an inlet coupling to receive the refrigerant; an outlet coupling to output the refrigerant; a first set of interconnections coupled with inlet and the set of coils at the first end of the set of coils to interconnect the first end of each of the coils with the inlet coupling; and a second set of interconnections coupled with the outlet and the set of coils at the second end of the set of coils to interconnect the second end of each of the coils with the outlet coupling.

Such embodiments may comprise the evaporative unit, wherein the evaporative unit is designed to facilitate airflow in a second general direction, which is substantially opposite of the one general direction, from the second end of the set of coils to the first end of the set of coils.

Such embodiments may comprise the evaporative unit, wherein the set of coils is physically designed to accommodate the airflow while ice accumulates on the medium.

Some embodiments may comprise a method comprising: controlling a temperature of a refrigerant on the low pressure side of an expansion valve via the expansion valve to be close to the freezing temperature of water; directing, via an evaporative unit, the refrigerant, which is a liquid which at close to the freezing temperature of water to cool, in a first general direction through an evaporator coil, tube, or plate; and directing an airflow across the coil, tube, or plate in a second general direction, wherein the second general direction is substantially the opposite of the first general direction.

Such embodiments may comprise the method, wherein directing an airflow across the coil, tube, or plate comprises transferring heat from the air to the refrigerant via thermally conductive materials from which the coil, tube, or plate is made, to reduce the airflow to less than 55 degrees Fahrenheit while crossing the coil, tube, or plate.

Such embodiments may comprise the method, wherein directing an airflow across the coil, tube, or plate comprises transferring heat from the air to the refrigerant via thermally conductive materials from which the coil, tube, or plate is made, to reduce the airflow to less than 45 degrees Fahrenheit while crossing the coil, tube, or plate.

Such embodiments may comprise the method, wherein directing an airflow across the coil, tube, or plate comprises transferring heat from the air to the refrigerant via thermally conductive materials from which the coil, tube, or plate is made, to reduce the airflow to approximately 32 degrees Fahrenheit while crossing the coil, tube, or plate.

Such embodiments may comprise the method, wherein directing an airflow across the coil, tube, or plate comprises transferring heat from the air to the refrigerant via thermally conductive materials from which the coil, tube, or plate is made, to reduce the airflow to approximately 32 degrees Fahrenheit while crossing the coil, tube, or plate and directing the airflow about ice buildup on the coil, tube, or plate.

Such embodiments may comprise the method, wherein directing airflow comprises directing airflow through a second medium about the coil, tube, or plate.

Such embodiments may comprise the method, wherein directing airflow through a second medium about the coil, tube, or plate comprises directing airflow through media, wherein each medium of the media encompasses at least one coil, tube, or plate of a set of coils, tubes, or plates.

Some embodiments may comprise a method for retrofitting a standard air conditioner with opposing direction evaporative coils to cool and dehumidify airflow, the method comprising: adjusting the direction of flow of a refrigerant through the evaporative coils to flow in a first direction that is substantially opposite to the flow direction of the airflow about the evaporative coils; coupling a thermostat to a return line of the refrigerant, the return line being a low-pressure line between the evaporator coils and a compressor; and coupling the thermostat to a variable airflow controller to determine adjustments for a rate of airflow across the evaporative coils; and coupling the variable airflow controller with an airflow unit to adjust the rate of airflow across the evaporative coils.

Such embodiments may comprise the method, wherein adjusting the direction of flow comprises replacement of existing evaporative coils of the standard air conditioner with an opposing direction, evaporative unit.

Such embodiments may comprise the method, wherein adjusting the direction of flow comprises adding an opposing direction, evaporative unit to existing evaporative coils of the standard air conditioner.

Such embodiments may comprise the method, wherein adjusting the direction of flow comprises modifying existing evaporative coils of the standard air conditioner to form opposing direction, evaporative coils and installing the opposing direction, evaporative coils to direct the refrigerant in a substantially opposite direction through the coils than the airflow across the coils.

Some embodiments may comprise an air-conditioning system with dehumidification, comprising: a compressor to compress a refrigerant; a condenser coil to couple with the compressor to receive the refrigerant from the compressor and output the refrigerant in a condensed form; a device to couple with the condenser coil to reduce the pressure of the refrigerant from the condenser coil to a pressure at which a temperature of the refrigerant is close to 32 degrees Fahrenheit; and an evaporator unit to couple with the device to receive the refrigerant, the evaporator unit to direct the refrigerant from a first side of the unit to a second side of the unit and direct airflow from the second side of the unit to the first side of the unit, wherein the refrigerant is to be at a first low temperature upon entering the first end of the unit and a first high temperature at the second end of the unit and the airflow is to be at a second high temperature at the second end of the unit and a second low temperature at the first end of the unit by conducting heat to the refrigerant prior to exiting into a conditioned space.

Such embodiments may comprise the air-conditioning system, further comprising a variable speed fan to vary the speed of the airflow through the evaporator unit based on the temperature of the refrigerant as it leaves the evaporator unit and returns to the compressor, or based on the temperature of the cooled air leaving the unit.

Such embodiments may comprise the air-conditioning system, further comprising an override temperature sensor coupled with override logic that speeds up the airflow if the coldest part of the coil freezes.

Such embodiments may comprise the air-conditioning system, wherein the variable speed fan comprises a direct current (DC) motor and circuitry coupled with the DC motor to vary the speed of rotation of the motor.

Such embodiments may comprise the air-conditioning system, wherein the variable speed fan comprises an alternating current (AC) motor and circuitry coupled with the AC motor to vary the speed of rotation of the motor or where louvers vary the volume of airflow.

Such embodiments may comprise the air-conditioning system, wherein the compressor comprises a variable speed compressor.

Such embodiments may comprise the air-conditioning system, further comprising a controller to adjust the speed of airflow by adjusting the speed of rotation of the variable speed fan.

Such embodiments may comprise the air-conditioning system, further comprising a controller to adjust the speed of airflow by adjusting the speed of rotation of the variable speed fan.

Such embodiments may comprise the air-conditioning system, wherein a refrigeration cycle of the air-conditioning system is designed to reduce the temperature of the airflow to approximately 34-40 degrees Fahrenheit (° F.) upon exiting the evaporative unit.

Such embodiments may comprise the air-conditioning system, wherein a refrigeration cycle of the air-conditioning system is designed to reduce the temperature of the airflow to less than 55° F. upon to exiting the evaporator unit.

Such embodiments may comprise the air-conditioning system, wherein a controller of the air-conditioning system is designed to adjust the airflow based upon a humidity setting, where a higher airflow at the same temperature in the conditioned air space creates higher humidity and vice versa.

Such embodiments may comprise the air-conditioning system, wherein the compressor speed or on/off setting is calculated from a combination of wet bulb and dry bulb temperature.

Such embodiments may comprise the air-conditioning system, further comprising a controller to adjust the speed of airflow by adjusting a position of one or more louvers.

Such embodiments may comprise the air-conditioning system, wherein the evaporative unit comprises at least one hollow plate, the hollow plate to direct refrigerant to accomplish an opposing direction, heat exchange between the airflow and the refrigerant.

Such embodiments may comprise the air-conditioning system, wherein the evaporative unit comprises at least two tubes with projections, each tube to direct refrigerant to accomplish an opposing direction, heat exchange between the airflow and the refrigerant.

Such embodiments may comprise the air-conditioning system, wherein the evaporative unit comprises at least two sets of coils, each set of coils to direct airflow to accomplish an opposing direction, heat exchange between the airflow and the refrigerant.

Such embodiments may comprise the air-conditioning system, further comprising a controller to adjust the adjust positions of one or more louvers to direct airflow across the at least two sets of coils in parallel for higher humidity or in series for lower humidity.

Such embodiments may comprise the air-conditioning system, further comprising a controller to adjust the positions of one or more louvers to direct at least part of the airflow through a path to bypass the coils of the evaporator unit to achieve low temperature/humidity in the air passing through the coils.

Some embodiments may comprise a retrofitted evaporative unit for an air-conditioning system comprising: an opposing direction, evaporative unit and a second coil coupled in series with the opposing direction, evaporative unit to compress a refrigerant.

Such embodiments may comprise the retrofitted evaporative unit, wherein opposing direction, evaporative unit is coupled on the incoming-air side of the second coil to condition the incoming air before the incoming air passes through the second coil.

Such embodiments may comprise the retrofitted evaporative unit, wherein opposing direction, evaporative unit is coupled on the outgoing-air side of the second coil to condition the incoming air after the incoming air passes through the second coil.

Such embodiments may comprise the retrofitted evaporative unit, further comprising one or more louvers to adjust the amount of airflow through one or both of the coils.

Some embodiments may comprise the retrofitted air-conditioning system comprising: a compressor to compress a refrigerant; a condenser coil to couple with the compressor to receive the refrigerant from the compressor and output the refrigerant in a condensed form; and an evaporative unit comprising an opposing direction, evaporative unit and a second coil coupled in series with the opposing direction, evaporative unit to compressor to compress a refrigerant.

Such embodiments may comprise the retrofitted air-conditioning system, wherein opposing direction, evaporative unit is coupled on the incoming air side of the second coil to condition the incoming air before the incoming air passes through the second coil.

Such embodiments may comprise the retrofitted air-conditioning system, wherein opposing direction, evaporative unit is coupled on the outgoing air side of the second coil to condition the incoming air after the incoming air passes through the second coil.

Such embodiments may comprise the retrofitted air-conditioning system, further comprising one or more louvers to adjust the amount of airflow through one or both of the coils.

Some embodiments may comprise an evaporative unit for an air-conditioning system, comprising: a set of coils, each coil of the set comprising a medium to transport a refrigerant in one general direction from a first end of the coil to the second end of the coil, the first end of each coil being at a first end of the set of coils and the second end of each coil being at a second end of the set of coils, the medium to conduct heat from an outside the medium to the refrigerant; an inlet coupling to receive the refrigerant; an outlet coupling to output the refrigerant; a first set of interconnections coupled with inlet and the set of coils at the first end of the set of coils to interconnect the first end of each of the coils with the inlet coupling; and a second set of interconnections coupled with the outlet and the set of coils at the second end of the set of coils to interconnect the second end of each of the coils with the outlet coupling.

Such embodiments may comprise the evaporative unit, wherein the set of coils is physically designed to contain the refrigerant in a liquid and gas state and a saturated vapor state.

Such embodiments may comprise the evaporative unit, wherein evaporative unit is designed to facilitate airflow in a second general direction, which is substantially opposite of the one general direction, from the second end of the set of coils to the first end of the set of coils.

Such embodiments may comprise the evaporative unit, wherein the set of coils is physically designed to accommodate the airflow while ice accumulates on the medium.

Some embodiments may comprise a method for airflow about an evaporator coil, the method comprising: receiving a refrigerant at an inlet coupling; transporting the refrigerant to the a first set of interconnections to distribute the refrigerant to a first end of a set of coils; transporting the refrigerant in one general direction from the first end of the set of coils to a second end of the set of coils through each coil of the set of coils in parallel; directing airflow from the second end of the set of coils to the first end of the set of coils, which is substantially the opposite direction of the one general direction, the airflow transferring heat to the refrigerant via each coil; and transporting the refrigerant out an outlet coupling at the second end of the set of coils upon arrival at the second end of the set of coils.

Such embodiments may comprise the method, wherein transferring heat comprises transferring heat at a substantially constant gradient as the airflow progresses from the first end of the coils to the second end of the coils.

Such embodiments may comprise the method, wherein transferring heat comprises transferring heat from the air to reduce the air temperature to less than 55° F.

Such embodiments may comprise the method, wherein transferring heat comprises transferring heat from the air to reduce the air temperature to less than 50° F.

Such embodiments may comprise the method, wherein transferring heat comprises transferring heat from the air to reduce the air temperature to less than 45° F.

Such embodiments may comprise the method, wherein transferring heat comprises transferring heat from the air to reduce the air temperature to less than 40° F.

Such embodiments may comprise the method, wherein transferring heat comprises transferring heat from the air to reduce the air temperature to less than 35° F.

Such embodiments may comprise the method, wherein transferring heat comprises transferring heat from the air to reduce the air temperature to approximately 32° F.

Such embodiments may comprise the method, wherein transferring heat comprises transferring heat from the air to reduce the air temperature to approximately 32° F. and accommodating airflow about ice buildup on the medium through which the refrigerant flows.

Such embodiments may comprise the method, wherein directing airflow comprises directing airflow through a second medium about the set of coils.

Such embodiments may comprise the method, wherein directing airflow through a second medium about the set of coils comprises directing airflow through media, wherein each medium of the media encompasses at least one of the coils of the set of coils.

Some embodiments may comprise an evaporator coil unit for an air-conditioning system, comprising: a set of coils, each coil of the set comprising a first medium to transport a refrigerant from a first end of the coil to the second end of the coil and a second medium to transport air from the second end to the first end, the air to be in contact with the first medium while within the second medium; an air inlet coupling coupled with the second medium at the second end to receive air to transport through the second medium; an air outlet coupling coupled with the second medium at the first end to receive air to transport through the second medium; a refrigerant inlet coupling to receive the refrigerant; an refrigerant outlet coupling to output the refrigerant; a first set of interconnections coupled with inlet coupling and the set of coils at the first and to interconnect the coils at the first end with the inlet coupling; and a second set of interconnections coupled with the outlet coupling and the set of coils at the second end of the set of coils to interconnect the second end with the outlet coupling.

Some embodiments may comprise a method for retrofitting a standard air conditioner with opposing direction, evaporator coils to create lower humidity, the method comprising: decoupling coils of a set of coils; coupling the coils to direct a refrigerant in one general direction from a first end of each of the coils to a second end of each of the coils; interconnecting the first end of each of the coils with an inlet coupling for the refrigerant; and coupling the second end of each of the coils with an outlet coupling.

Some embodiments may comprise a method for manufacturing an opposing direction evaporator coil unit, the method comprising: interconnecting coils having one general direction of flow from a first end of each of the coils to a second end of each of the coils, wherein interconnecting comprises coupling the first end of each of the coils with an inlet coupling and coupling a second end of each of the coils with an outlet coupling to facilitate flow of refrigerant through the first end of each of the coils to the second end of each of the coils; and mounting the coils in a frame to create the opposing direction evaporator coil unit.

Some embodiments may comprise a method for creating a design for manufacturing of an opposing direction evaporator coil unit, the method comprising: generating a schematic for interconnecting coils having one general direction of flow from a first end of each of the coils to a second end of each of the coils, wherein interconnecting comprises coupling the first end of each of the coils with an inlet coupling and coupling a second end of each of the coils with an outlet coupling to facilitate flow of refrigerant through the first end of each of the coils to the second end of each of the coils; and generating a schematic for mounting the coils in a frame to create the opposing direction evaporator coil unit with interconnections of the schematic for interconnecting the coils.

Some embodiments may comprise an air-conditioning system with dehumidification, comprising: a compressor to compress a refrigerant; a condenser coil to couple with the compressor to receive the refrigerant from the compressor and output the refrigerant in a condensed form; a device to couple with the condenser coil to reduce the pressure of the liquid from the condenser coil to a pressure close to 32° F.; and an evaporator coil unit to couple with the device to receive the refrigerant, the evaporator coil unit to direct the refrigerant from a first side of the unit to a second side of the unit and direct airflow from the second side of the unit to the first side of the unit, wherein the refrigerant is to be at a first low temperature upon entering the first end of the unit and a first high temperature at the second end of the unit and the airflow is to be at a second high temperature at the second end of the unit and a second low temperature at the first end of the unit by conducting heat to the refrigerant prior to exiting into a conditioned environment.

Such embodiments may comprise the air-conditioning system, further comprising a variable speed fan to vary the speed of the airflow through the evaporator coil unit based on the temperature of the refrigerant as it leaves the evaporator coil and returns to the compressor, or based on the temperature of the cooled air leaving the unit.

Such embodiments may comprise the air-conditioning system further comprising an override temperature sensor, which speeds up the airflow if the coldest part of the coil freezes.

Such embodiments may comprise the air-conditioning system, wherein the variable speed fan comprises a direct current (DC) motor and circuitry coupled with the DC motor that vary the speed of rotation of the motor.

Such embodiments may comprise the air-conditioning system, wherein the variable speed fan comprises an alternating current (AC) motor and circuitry coupled with the AC motor to vary the speed of rotation of the motor or where louvers vary the volume of airflow.

Such embodiments may comprise the air-conditioning system, wherein the compressor comprises a variable speed compressor.

Such embodiments may comprise the air-conditioning system, further comprising a controller to adjust the speed of airflow by adjusting the speed of rotation of the variable speed fan.

Such embodiments may comprise the air-conditioning system, further comprising a controller to adjust the speed of airflow by adjusting the speed of rotation of the variable speed fan.

Such embodiments may comprise the air-conditioning system, wherein a refrigeration cycle of the air-conditioning system is designed to reduce the temperature of the airflow to approximately 34-40 degrees Fahrenheit upon to exiting the evaporator coil unit.

Such embodiments may comprise the air-conditioning system, wherein a refrigeration cycle of the air-conditioning system is designed to reduce the temperature of the airflow to less than 55 degrees Fahrenheit upon to exiting the evaporator coil unit.

Such embodiments may comprise the air-conditioning system, wherein a controller of the air-conditioning system is designed to adjust the airflow based upon a humidity setting.

Such embodiments may comprise the air-conditioning system, wherein the compressor speed or on/off setting is calculated from a combination of wet bulb and dry bulb temperature.

Such embodiments may comprise the air-conditioning system, further comprising a controller to adjust the speed of airflow by adjusting a position of one or more louvers.

Such embodiments may comprise the air-conditioning system, wherein the evaporator coil unit comprises at least two sets of coils, each set of coils to direct airflow to accomplish a opposing direction heat exchange between the airflow and the refrigerant.

Such embodiments may comprise the air-conditioning system, further comprising a controller to adjust the adjust positions of one or more louvers to direct airflow across the at least two sets of coils in parallel or in series.

Such embodiments may comprise the air-conditioning system, further comprising a controller to adjust the positions of one or more louvers to direct at least part of the airflow through a path to bypass the coils of the evaporator coil unit.

Some embodiments may comprise an air-conditioning system with dehumidification, comprising: a compressor to compress a refrigerant; a condenser coil to couple with the compressor to receive the refrigerant from the compressor and output the refrigerant in a condensed form; an device to couple with the condenser coil to change the pressure of the liquid from the condenser coil; an evaporator coil unit to couple with the device to receive the refrigerant, the evaporator coil unit to direct the refrigerant from a first side of the unit to a second side of the unit and direct airflow from the second side of the unit to the first side of the unit, to transfer heat from the airflow to the refrigerant via a opposing direction heat exchange process.

Some embodiments may comprise an air-conditioning system with dehumidification, comprising: a compressor to compress a refrigerant; a condenser coil to couple with the compressor to receive the refrigerant from the compressor and output the refrigerant in a condensed form or alternately to receive water chilled to roughly 0 degrees Celsius (° C.); an expansion valve, capillary tubing or other device between the condenser coil and the condenser coil which maintains high pressure in the condenser coil and lower pressure in the evaporator coil; an evaporator coil unit to couple with the device to receive the refrigerant, from the evaporator coil unit to direct the refrigerant from a first side of one or more coils to a second side of the one or more coils, to transfer heat from the airflow to the refrigerant within the coils via a opposing direction heat exchange process.

Some embodiments may comprise an air-conditioning system with dehumidification, comprising: a compressor to compress a refrigerant; a condenser coil to couple with the compressor to receive the refrigerant from the compressor and output the refrigerant in a condensed form; a device to couple with the condenser coil to change the pressure of the liquid from the condenser coil; and an evaporator coil unit to couple with the device to receive the refrigerant, the evaporator coil unit to direct the refrigerant through a set of coils to transfer heat from the airflow to the refrigerant within the coils via an opposing direction heat exchange process.

Some embodiments may comprise an air-conditioning system with dehumidification, comprising: a compressor to compress a gas refrigerant; a condenser coil to couple with the compressor to receive the high pressure gas refrigerant from the compressor and output the refrigerant in a condensed/liquid form; a device to couple with the condenser coil to maintain a pressure drop between the condenser and evaporator coils the pressure of the liquid from the condenser coil; and an evaporator coil unit to couple with the device to receive the refrigerant, the evaporator coil unit to direct the refrigerant through a set of coils to transfer heat from the airflow to the refrigerant within the coils by directing the airflow along a substantially parallel path with the refrigerant but in the opposite direction, wherein the pressure in the evaporator coil is maintained to achieve a temperature at or slightly above 0° F.

Some embodiments may comprise an method for controlling temperature and humidity in a controlled environment, the method comprising: compressing a refrigerant at a saturated vapor state to achieve a superheated vapor; directing the refrigerant in the superheated vapor state through a condenser wherein heat is transferred from the refrigerant to achieve a saturated liquid state; directing the refrigerant in the saturated liquid state through an expansion valve to achieve a liquid and vapor state; and directing the refrigerant through an opposing direction evaporator coil to transfer heat to the refrigerant from an airflow via at a substantially constant gradient across the length of a set of coils by directing the airflow from a first end of the set of coils to a second end of the set of coils in generally an opposing direction with which the refrigerant travels through the set of coils.

Some embodiments may comprise an method for controlling temperature and humidity in a controlled environment, the method comprising compressing a refrigerant at a saturated vapor state to achieve a superheated vapor; directing the refrigerant in the superheated vapor state through a condenser wherein heat is transferred from the refrigerant to achieve a saturated liquid state; directing the refrigerant in the saturated liquid state through an expansion valve to achieve a liquid and vapor state; and directing the refrigerant through an opposing direction evaporator coil to transfer heat to the refrigerant from an airflow across the length of a set of coils by directing the airflow from a first end of the set of coils to a second end of the set of coils in generally an opposite direction with which the refrigerant travels through the set of coils.

Some embodiments may comprise an method for controlling temperature and humidity in a controlled environment, the method comprising: compressing a refrigerant at a saturated vapor state to achieve a superheated vapor; directing the refrigerant in the superheated vapor state through a condenser wherein heat is transferred from the refrigerant to achieve a saturated liquid state; directing the refrigerant in the warm liquid state through an expansion valve to achieve a cold liquid and vapor state; and directing the refrigerant through a opposing direction evaporator coil to transfer heat to the cold refrigerant from an airflow across the length of a set of coils by directing the refrigerant through the coils in one general direction and directing the airflow about the coils in a direction that is substantially opposite of the one general direction.

Some embodiments may comprise a controller for a opposing direction evaporative coil air-conditioning system, comprising: a thermostat input to control an exit air temperature, either directly or indirectly by controlling the low side refrigerant temperature, at an exit of airflow from an opposing direction evaporator coil of the opposing direction air-conditioning system to adjust the exit air temperature to slightly above freezing, or to the lowest temperature consistent with a high SEER rating for the refrigerant used in the system.

Some embodiments may comprise a controller for a opposing direction air-conditioning system, comprising: a thermostat input to indicate an exit air temperature at an exit of airflow from a opposing direction evaporator coil of the opposing direction air-conditioning system; a variable speed airflow output to couple with a variable speed airflow unit of the opposing direction air-conditioning system to transmit a signal to the variable speed airflow unit; and opposing direction logic coupled with the input and the output to transmit a signal to adjust airflow rate via the variable speed airflow unit of the opposing direction air-conditioning system through a opposing direction evaporator coil to transfer heat to the refrigerant from the airflow across the length of a set of coils of the opposing direction evaporator coil by directing the refrigerant through the coils in one general direction and directing the airflow about the coils in a direction that is substantially opposite of the one general direction, the logic to adjust the airflow rate to adjust the exit air temperature to slightly above freezing.

Some embodiments may comprise a method for controlling a opposing direction air-conditioning system, comprising: receiving an exit air temperature via a thermostat input to indicate the exit air temperature at an exit of airflow from a sensor in proximity with a opposing direction evaporator coil of the opposing direction air-conditioning system or indirectly by measuring the temperature of the refrigerant leaving the expansion coil; determining, via opposing direction logic coupled with the input, a signal to adjust an airflow rate to adjust the exit air temperature from a set of coils of a opposing direction evaporator coil to slightly above freezing via the variable speed airflow unit of the opposing direction air-conditioning system through the opposing direction evaporator coil, to transfer heat to the refrigerant from the airflow across the length of the set of coils of the opposing direction evaporator coil by directing the refrigerant through the coils in one general direction and directing the airflow about the coils in a direction that is substantially opposite of the one general direction; outputting the signal via a variable speed airflow output to a variable speed airflow unit of the opposing direction air-conditioning system to transmit a signal to the variable speed airflow unit.

Some embodiments may comprise a computer program product comprising: a computer-readable storage medium to store instructions for controlling a opposing direction air-conditioning system, which when executed, cause a computer to perform operations, the operations comprising: receiving an exit air temperature via a thermometer input to indicate the exit air temperature at an exit of airflow from a sensor in proximity with an opposing direction evaporator coil of the opposing direction air-conditioning system, or alternately the temperature of the coolant exiting from the evaporator coil; determining, via logic coupled with the input, a signal to adjust an airflow rate to adjust the exit air temperature or low side refrigerant temperature from a set of coils of a opposing direction evaporator coil to slightly above freezing via the variable speed airflow unit of the opposing direction air-conditioning system through the opposing direction evaporator coil, to transfer heat to the refrigerant from the airflow across the length of the set of coils of the opposing direction evaporator coil by directing the refrigerant through the coils in one general direction and directing the airflow about the coils in a direction that is substantially opposite of the one general direction; outputting the signal via a variable speed airflow output controller to a variable speed airflow unit of the opposing direction air-conditioning system to transmit a signal to the variable speed airflow unit.

Some embodiments may comprise an air conditioner evaporator unit coil (the inside cooling coil which cools the air), which utilizes an airflow direction and cooling fluid direction in the cooling coil which are in opposing directions.

Some embodiments may comprise an air-conditioning system comprising an air conditioner evaporator unit coil (the inside cooling coil which cools the air), which utilizes an airflow direction and cooling fluid direction in the cooling coil which are in opposing directions.

Such embodiments may comprise the air-conditioning system of claim 200, comprising a thermostat coupled to a variable air unit to achieve an exit air temperature slightly above freezing regardless of the incoming temperature or humidity, wherein the exit air temperature is the temperature sensed for refrigerant exiting the opposing direction evaporator coil toward a compressor of the air-conditioning system.

Some embodiments may comprise a variable speed air or adjustable duct used to adjust the flow rate of air across the condensing unit coils such that exit air is close to 0° C. but just warm enough to avoid ice build-up on the coils, depending on the type of refrigerant used.

Such embodiments may comprise the variable speed air or adjustable duct, wherein the temperature of the airflow exiting the opposing direction evaporator coil is measured to determine adjustments to change the speed of the airflow.

Such embodiments may comprise the variable speed air or adjustable duct, wherein the temperature of the refrigerant exiting the opposing direction evaporator coil to return to the compressor is measured to determine adjustments to change the speed of the airflow.

Such embodiments may comprise the variable speed air or adjustable duct, wherein the temperature of the refrigerant at a location in the evaporator coil is determined via a sensor to control the airflow speed.

Such embodiments may comprise the variable speed air or adjustable duct, wherein a sensor determines ice build up to control the airflow speed.

Such embodiments may comprise the variable speed air or adjustable duct, wherein the input temperature controls the air speed, wherein an algorithm determines what air speed is needed to achieve a cold exit temp w/o ice accumulation.

Such embodiments may comprise the variable speed air or adjustable duct, wherein a combination if input air temperature and input air humidity controls air speed.

Such embodiments may comprise the variable speed air or adjustable duct, wherein coil resistance to airflow is used as an indication of ice buildup.

Such embodiments may comprise the variable speed air or adjustable duct, wherein the low-side refrigerant temperature controls air speed.

Such embodiments may comprise the variable speed air or adjustable duct, wherein a combination of the above controls the air speed.

Some embodiments may comprise a controller for an air-conditioning system to couple with the air-conditioning system to control the airflow through a counter current evaporator coil unit, wherein the controller comprises logic to control a variable speed fan by receiving sensor data to adjust variable airflow rate to where the flow is low enough to allow ice to build up on the evaporator coils and periodically cycle the flow high enough to melt the accumulated ice.

Some embodiments may comprise an air-conditioning system where the temperature of evaporation of the refrigerant is set close to 0° C. so as to avoid ice build up on the evaporator coil while maintaining the ability to cool air to close to freezing temp. (0° C.), eg, an embodiment may be designed with sufficient thermal gradient/resistance between air and refrigerant to work at roughly −2° C. to +6° C. for the boiling temperature of the liquid refrigerant in the evaporator coil.

Some embodiments may comprise an air-conditioning system where a multi-position or infinitely variable controller is utilized with the above claims to vary fan speed or louver position; which in-turn varies air-flow rate, and where zero may be one of the settings.

Some embodiments may comprise an air-conditioning system where the substantially freezing temperature of the exit air is achieved by switching between fast and slow airflow rates, the switching frequency being fast enough to maintain air exit temperature within a relatively narrow and acceptable band.

Some embodiments may comprise an air-conditioning system where ice is allowed to accumulate in the evaporator unit and then either the airflow rate is increased or the compressor is turned off allowing the ice to melt and then the cycle is repeated, such that air contact with ice maintains air exit temperature at or close to 0° C.

Some embodiments may comprise an air-conditioning system where the airflow rate is increased, and/or the airflow direction is reversed with regard to the refrigerant flow direction through the cooling coil when a higher humidity is desired.

Some embodiments may comprise an air-conditioning system where the airflow can be switched from the increased dehumidification configuration to a standard configuration so that room humidity can be lower or normal.

Some embodiments may comprise an evaporator cooling coil where the liquid refrigerant enters at or near the bottom and air enters from the top so that gravity helps keep the liquid refrigerant in the last coils the air passes by and so that the first coils the incoming air passes by are mostly gas filled.

Some embodiments may comprise an air-conditioning system where various other characteristics of air-conditioning systems may be incorporated, such as a set back thermometer, heat pump, ground loop a/c or ground loop heat pump, variable speed compressor, and/or heater assembly.

Some embodiments may comprise an air-conditioning system where the load on the compressor is designed to be smaller than the size of the compressor in a standard A/C system to account for the expected lower cooling demand resulting from the production of lower humidity air. In further embodiments, the smaller compressor load may be determined based upon heuristic data.

Some embodiments may comprise an air-conditioning system where a microprocessor or other intelligent/sophisticated controller is incorporated to maintain the exit air temperature close to freezing by one or more or all of the following functions: adjusting the airflow rate through the opposing direction evaporator coil; increasing the airflow rate in response to an instruction to increase humidity; reversing the airflow direction through the opposing direction coil to increase humidity; cycling between fast and slow airflow rates; cycling between forward and reverse airflow directions through the opposing direction evaporator coil; cycling the compressor on and off to freeze and melt ice to maintain an air exit temperature from the evaporator coil at or close to 0° C.; to vary fan speed or louver position; which in-turn varies air-flow rate, and where zero may be one of the settings; switching between fast and slow airflow rates, the switching frequency being fast enough to maintain air exit temperature within a relatively narrow and acceptable band; setting the temperature of evaporation of the cooling fluid close to 0° C. so as to avoid ice build up on the evaporator coil while maintaining the ability to cool air to close to freezing temp; and setting the temperature of evaporation of the refrigerant close to 0° C. with sufficient thermal gradient/resistance between air and refrigerant to work at roughly −2° C. to +6° C. for the boiling temp of the liquid refrigerant in the evaporator coil.

### BRIEF DESCRIPTION OF THE DRAWINGS

FIG. 1 depicts an embodiment of an air-conditioning (A/C) system;

FIG. 2 depicts an embodiment of an evaporator unit comprising a coil arrangement;

FIG. 3 depicts another embodiment of an evaporator unit comprising a coil arrangement;

FIG. 4 depicts concentric embodiments of evaporator units comprising coil arrangements;

FIG. 5 depicts an embodiment of an evaporator unit comprising tubing with projections;

FIG. 6 depicts an embodiment of an evaporator unit comprising a hollow plate;

FIG. 7 depicts an embodiment of an air-handling cabinet designed to achieve variable-speed, airflow by use of a variable speed fan;

FIG. 8 depicts an embodiment designed to achieve variable-speed, airflow by use of louvers;

FIG. 9 depicts an embodiment designed to achieve variable-speed, airflow by use of louvers as well as an incremental change-over from evaporative units in series to evaporative units in parallel;

FIGS. 10-12 depict embodiments designed to achieve an inherent airflow based upon migration of cooled air downward as well as variable-speed, airflow by use optional fans and louvers;

FIG. 13 depicts an embodiment of an A/C controller;

FIG. 14 depicts another embodiment of an A/C controller;

FIG. 15 illustrates an embodiment of a flow chart for an opposing direction, evaporative unit comprising a coil;

FIG. 16 illustrates an embodiment of a flow chart for a variable air unit;

FIG. 17 illustrates an embodiment of a flow chart for a variable air unit comprising a variable speed fan; and

FIG. 18 illustrates an embodiment of a flow chart for a variable air unit comprising one or more louvers.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

### INTRODUCTION

Generally, air-conditioning with dehumidification is described herein. Embodiments may involve methods and arrangements that utilize or comprise logic such as hardware and/or code for cooling and dehumidifying outgoing air. Some embodiments comprise an opposing direction, evaporative unit. The opposing direction, evaporative unit uses what may be referred to as an opposing direction flow, which directs airflow across a coil, plate, tube, tube with projections, or other evaporative units that comprise a refrigerant flowing in a direction that is generally the opposite direction of the airflow. In other words, the opposing direction flow utilized by the opposing direction, evaporative unit allows the air and refrigerant to enter at opposite ends, flow in generally opposite directions, and leave at opposite ends of the evaporative unit. The heat exchange process of this opposite direction flow allows for a smaller and more consistent temperature gradient throughout the heat exchange process. It is this consistent temperature gradient that allows many embodiments to achieve low air temperatures at the output of the indoor unit which will lead to the desired low humidity levels in the air conditioned space. In some embodiments, the temperature gradient is substantially constant as the airflow progresses from the first end of the evaporative unit to the second end of the evaporative unit.

Refrigerant lines may connect the indoor and outdoor units of an A/C system. Refrigerant comes out of the compressor of the outdoor unit at an elevated temperature and pressure, in its vapor state. This hot vapor then runs through the condenser, which transfers heat from the hot gas to the air. The liquefied refrigerant may then go through an expansion valve where both the pressure and temperature of the refrigerant will drop drastically. This cold refrigerant then enters the evaporative unit where it absorbs heat from the warm air. The exiting cold air is directed into the living space or other conditioned space. After leaving the evaporative unit, the warmed gas refrigerant enters the compressor where it begins the cycle again.

In order to understand advantages of embodiments that utilize the opposing direction, evaporative unit, its important to understand how much of a factor humidity is on a person's comfort level by understanding how the human body cools itself. The average human body produces 400 BTU/hr, about 117 watts, of heat that it must dissipate to maintain a normal body temperature of 98.6° F. To accomplish this, the body uses conduction, radiation, evaporation, convection, and breathing as methods to dissipate heat. The body provides as much cooling as possible by convection and radiation, then makes up the difference with evaporation. As the room temperature rises, less and less cooling can be provided by convection and radiation and more and more cooling must be provided by evaporation. In fact, evaporation becomes the main heat transfer mechanism when the room temperature rises above 80° F.

Evaporation is dependent upon the humidity level of the surrounding air. As a person sweats, the water (sweat) evaporates into the air. The energy used to convert water into vapor is called the heat of vaporization. The heat of vaporization of water, which is 580 cal/g, is the energy that is responsible for cooling the body. In other words, for every gram of sweat, or moisture loss from breathing, a person produces, 580 calories of energy is removed from the body. Note that sweating also cools air next to the body so not all 580 cal of cooling is absorbed.

Humidity plays an important part in evaporative cooling because it determines how willing the air is to convert the sweat into vapor. At zero percent humidity every gram of sweat will be evaporated, providing the body with the maximum level of cooling. Conversely, warm air at one hundred percent humidity will not be willing to evaporate any sweat and no cooling will be provided.

A person will receive almost twice as much cooling at 85° F. and 40% relative humidity than they would at 80° F. and 60% relative humidity.

In order to achieve the lowest humidity, the supply air coming out of the air-conditioning unit must be at the lowest economically achievable temperature. The normal supply air temperature of a standard air conditioner is 55° F. The desired supply air temperature for many embodiments described herein is as close to 32° F. (0° C.) as practical. Achieving this lower supply air temperature level will allow more water to be condensed out of the room, which would cause the humidity level in the room to be lower.

Results of the testing showed that an A/C system modified in accordance with one embodiment could provide humidity levels in the living area up to 15% relative humidity better than what the standard unit could achieve. This decreased humidity level can allow users to feel more comfortable enabling them to leave their thermostats set to a higher temperature. This will cut their energy use for cooling.

To maintain an exiting airflow as close to 32° F. as practical, many embodiments utilize an opposing direction (air vs. refrigerant), evaporative unit and a variable air unit to monitor and vary airflow for an air-conditioning system to substantially maximize transference of heat from air flowing across an evaporative unit to the refrigerant flowing through the unit. In many embodiments, the airflow is monitored and varied via an air-conditioner controller that is also typically used by a user to input settings for the air-conditioning system. In other embodiments, logic in proximity to the variable speed unit may automatically control the speed of the airflow with little or no input from an air conditioner controller.

In some embodiments, logic varies airflow by varying the speed or rotations per minute (RPMs) of a fan motor. Further embodiments adjust the positions of louvers or similar members to adjust the proportion of airflow that is directed across the evaporative unit. In several embodiments, the louvers may adjust the airflow to switch between directing air across two or more evaporative units in parallel to directing air across two or more evaporative units in series. Some of these embodiments comprise multiple banks of, e.g., two or more coils that can be adjusted to direct airflow across the two or more coils in each bank in parallel or each and several of these embodiments facilitate independent adjustment of the louvers in each of the banks of coils. Still further embodiments combine the variable speed fan with the louvers.

In some embodiments, the variable air unit may operate in conjunction with a conventional evaporative coil. In several embodiments, the evaporative unit may comprise an opposing direction, evaporative coil and the transference of heat from the air to the coil may be substantially maximized by maintaining an exiting air temperature just above the freezing point for water to avoid the accumulation of ice on the opposing direction, evaporative coil. Other embodiments may be designed to cycle on and off allowing the buildup of ice on the coils and the melting of the ice on the coils in cycles. Still other embodiments may maintain a layer of ice on the coils once the system reaches steady state operation.

Another embodiment of the evaporator units is a long vertical unit, which uses the higher density of colder air to create all or most of the airflow past the unit. (Just as hot air rises in a chimney, air cooled by evaporator units will fall, thus causing airflow past the units. The evaporator units may be inside a chase (duct) to enhance this effect and to capture warmer air near the ceiling and deposit that same air, after it is cooled, after it travels past the evaporator units, down the duct, closer to the floor. In some embodiments, a long vertical evaporator unit such as a coil coupled in conjunction with a multi-speed compressor and variable speed or multispeed air offer increased efficiency and is simultaneously effective at dehumidification. Evaporator units may comprise projections such as spikes or fins or may be without fins to facilitate cleaning Folded coils of a typical A/C unit may used instead and may consist of a more-or-less flat sheet.

Many embodiments comprise an air conditioner controller to control the speed of the fan(s), positioning of the louver(s), whether the compressor is on or off, and/or the RPMs of the compressor. In further embodiments, the air conditioner controller may control turn on and off the fan for the condensing coils and/or control the RPMs of the fan for the condensing coils.

One embodiment comprises an air conditioner controller that operates using enthalpy-based control, instead of temperature-based control. An enthalpy-based air conditioner controller may remove the reliance on the user to adjust the set point on their thermostat when they feel uncomfortable. The enthalpy-based air conditioner controller may allow the user to set a desired temperature level and, based upon this desired temperature setting, calculate the enthalpy level of the air if a normal air-conditioning unit were to bring the room to that temperature. This enthalpy-based air conditioner controller may measure the temperature and humidity level in the living space and calculate or otherwise determine the current enthalpy level of the air in the living space. Once the enthalpy level of the living space matches the calculated/determined enthalpy level, the air conditioner controller may cycle off and on the air-conditioning system to maintain the enthalpy level. Controlling the air-conditioning system in such a way may increase the ease of use for the customer and increase the energy savings for the system.

In further embodiments, the air conditioner controller comprises a wet bulb thermostat or comprises a combination of wet bulb temperature with a standard (dry bulb) thermostat. In the latter embodiment, the user of the conditioned space may set, for example, the air conditioner controller to a temperature based upon a weighted combination of the wet bulb reading and the dry bulb reading such as a temperature based upon 50% of the wet bulb temperature and 50% of the dry bulb temperature. A wet bulb is a thermometer covered by a wet sleeve, which provides humidity-dependent cooling proportional to the evaporation from the sleeve. Since a person cools partly by evaporation, an accurate thermometer to track the comfort level of a person would provide a temperature roughly half way between wet bulb and dry bulb temperature. It is not necessary to maintain a constantly wet bulb because the “wet bulb” temperature can be calculated based on the dry bulb temperature and the relative humidity as provided by a humidity meter. Therefore one embodiment incorporates a humidity sensor or a wet bulb temperature sensor into the thermostat to determines if A/C cooling is required.

While some of the specific embodiments described below will reference the embodiments with specific configurations, those of skill in the art will realize that embodiments of the present disclosure may advantageously be implemented with other configurations with similar issues or problems.

### A/C System

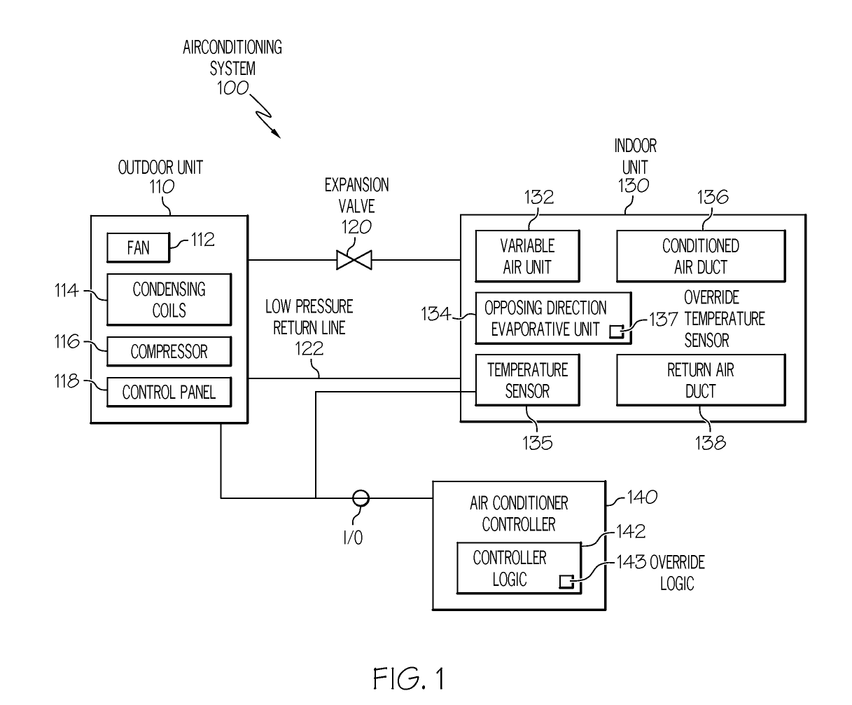

FIG. 1 shows an embodiment of the components of an air-conditioning (A/C) system 100. The A/C system 100 may comprise a window air-conditioning unit, a portable A/C unit in which the outdoor unit is connected to an “outdoor” area via tubing, a central A/C system for a single family residence, a multiple-family residence, a commercial building, an office building, or an industrial building, or the like.

A/C system 100 may implement methods that involve a heat exchanger or heat exchange unit comprising one or more evaporation (cooling) units referred to as opposing direction, evaporator unit 134. The opposing direction, evaporator unit 134 has the refrigerant, such as R22 or other coolant medium, flow in a direction that is at least generally opposite to the airflow direction as well as an adjustable airflow rate. The adjustable airflow rate may take advantage of such a unit's 134 ability to produce both cold (dehumidified) exit air and fully warmed exit refrigerant (for high efficiency) through airflow rate adjustment until airflow is just sufficient to avoid cold refrigerant returning to the compressor. A device such as an expansion valve 120 may have a primary responsibility to assure that the coils are cold but not freezing but there is some interplay between air speed and icing of the unit 134. This may produce low humidity even when the room thermostat is set warm (e.g. 85° F.) which may result in 5%-25% to lower energy usage for the A/C system 100 and, thus, 5%-25% lower energy bills.

Some embodiments of A/C system 100 may be a standard A/C system that has been retrofitted to include the opposing direction, evaporator unit 134. Such retrofits may involve replacing the existing, standard evaporative coil with the opposing direction, evaporator unit 134 or adding the opposing direction, evaporator unit 134 in series with the standard evaporative coil. In some retrofit embodiments, incoming airflow passes through the standard evaporative coil after passing through the opposing direction, evaporator unit 134. In other retrofit embodiments, incoming airflow passes through the standard evaporative coil before passing through the opposing direction, evaporator unit 134. In further retrofit embodiments, a louver arrangement may be installed to determine the amount of airflow through the existing coil, the opposing direction, evaporator unit 134, or, in some embodiments, both the existing coil and the opposing direction, evaporator unit 134.

Retrofitting the A/C system 100 may also involve coupling temperature sensor 135 to a return line 122 of the refrigerant between the opposing direction, evaporator unit 134 and a compressor 116, coupling the temperature sensor 135 to a variable airflow controller such as air-conditioner controller 140 or a controller in indoor unit 130 to determine adjustments for a rate of airflow across the opposing direction, evaporator unit 134, and coupling the variable airflow controller with a variable air unit 132 to adjust the rate of airflow across the opposing direction, evaporator unit 134. Retrofitting the A/C system 100 may also require installation of a drip pan for the opposing direction, evaporator unit 134.

In many embodiments, A/C system 100 may comprise an override to allow for higher humidity by increasing the air speed beyond the air speed determined for maintaining the unit 134 near freezing. In the present embodiment, controller logic 142 of A/C controller 140 comprises override logic 143 for overriding the humidity setting by increasing air speed across unit 134 via variable air unit 132. Alternatively, A/C system 100 could be configured to produce a desired (as input into A/C controller 140) humidity. Larger homes in areas of high humidity and heat, for example, may be early adopters of systems that have both temperature and humidity settings. A/C system 100, by progressively attenuating the ability to dehumidify the exiting air, may be able to produce a broad range of humidity levels for a selected temperature setting.

In some embodiments, A/C system 100 is designed to achieve lower humidity for applications such as low-income apartments, where occupants typically set the temperature uncomfortably high to save on A/C costs and where a standard A/C does not, in such conditions, provide sufficient dehumidification. The estimated savings may range from about 15% to 20% reduction in relative humidity reduction of about 20%.

While the A/C system 100 illustrates a single outdoor unit 110 and a single indoor unit 130, other embodiments may comprise multiple indoor units and/or multiple outdoor units. For instance, a single outdoor unit may service more than one indoor units. Furthermore, the following discussion implements a vapor compression refrigeration cycle but other refrigeration cycles are employed in alternative embodiments.

The refrigerant lines connect the outdoor and indoor units 110 and 130 of the A/C system 100 via connections or couplings on the units 110 and 130 or on components within the units 110 and 130 and may comprise, e.g., copper tubing, aluminum tubing, rubber tubing with a steel mesh jacket, plastic tubing such as polyvinyl chloride (PVC) tubing, or other appropriate interconnections. The couplings or connections may comprise fitting designed for the particular type of tubing utilized and the type and temperatures of the refrigerant.

The outdoor unit 110 may comprise a fan 112, condensing coils 114, a compressor 116, and a control panel 118. Incoming liquid refrigerant such as R22 or other coolant may be received in a saturated vapor state at the outdoor unit 110 via a low-pressure return line 122. The saturated vapor refrigerant may be compressed via compressor 116 to a superheated vapor state. The superheated vapor refrigerant is transported to the condensing coils 114. As the superheated vapor refrigerant is transported through the condensing coils, fan 112 may pull or push air across the condensing coils 114 to condense the superheated vapor refrigerant to a saturated liquid state. Note that either an expansion valve 120 or capillary tubing is placed between the condenser coil and the low pressure, opposing direction, evaporator unit 134 to maintain sufficient back pressure on the compressor 116 for the compressor 116 to liquefy the refrigerant in the outside condensing coils 114. After the capillary tubing/expansion valve, the pressure is low enough that the refrigerant boils at roughly 0 to 10° C.

The expansion valve 120 abruptly reduces the pressure of the refrigerant causing an adiabatic flash evaporation of a part of the saturated liquid refrigerant, which lowers the temperature of the refrigerant and changes the refrigerant to a liquid and vapor mixture. The liquid and vapor mixture of refrigerant enters the opposing direction, evaporative unit 134, inside the indoor unit 130

The indoor unit 130 comprises a return air duct 138 to receive air from an air conditioned space and a variable air unit 132 to adjust the airflow rate of the air entering from the return air duct 138 through or over the opposing direction, evaporative unit 134 and out the conditioned air duct 136 to the air conditioned space. In many embodiments, indoor unit 130 may also include other modules such as heater modules, air filtration modules, air ionization modules, humidification modules, or the like.

The variable air unit 132 is designed to adjust the airflow rate through the opposing direction, evaporative unit 134. In many embodiments, the variable air unit 132 may be controlled via A/C controller 140. In some embodiments, the air speed is adjustable and it is adjusted to be just fast enough to prevent the unit 134 from freezing, but in the some embodiments the air speed is barely enough to fully warm (still cool but not cold) the refrigerant before it returns to the compressor and an expansion valve 120 controls the coldest temperature in the unit 134 to just above freezing. Since there is a latent temperature difference between the refrigerant inside the pipes and the air being cooled by passing through the unit 134, air speed also determines whether the unit 134 will ice up, so air speed may also be adjusted to prevent ice-up. Lower flow through A/C ducts makes it easier to restrict the air flow to just the rooms occupied (bedrooms at night) without creating back pressure higher than a standard A/C is designed to accommodate. For a warm room temperature and clean, e.g., evaporative coils, some embodiments utilize an air speed of roughly ⅓ of standard, which provides a fan energy consumption of about ⅕, or 20%

The variable air unit 132 may comprise one or more louvers, fans, valves, or other such devices to regulate the rate of airflow through the opposing direction, evaporative unit 134 to dehumidify the air. In some embodiments, the variable air unit 132 may reverse the airflow through the opposing direction, evaporative unit 134 to minimize dehumidification of the air. For example, the variable air unit 132 may comprise a variable speed fan. In other embodiments, the variable air unit 132 may comprise a louver capable of restricting airflow through the opposing direction, evaporative unit 134 by allowing air to bypass the opposing direction, evaporative unit 134, partially blocking airflow into or over the opposing direction, evaporative unit 134, or both. In a further embodiment, the variable air unit 132 may comprise a variable speed fan and louvers to bypass the opposing direction, evaporative unit 134 and/or reverse airflow through the opposing direction, evaporative unit 134.

An opposing direction flow is utilized in some embodiments via the evaporative unit 134 to increase dehumidification. The refrigerant enters evaporative unit 134 where the air exists, and exits where the air enters. The direction of the flow of refrigerant is generally parallel but opposite to the flow of air across evaporative unit 134. As the refrigerant flows through the evaporative unit 134, it comes in contact with progressively warmer air. At the end of its passing, the refrigerant may be in contact with room temperature air, thus being fully removed of its cooling capacity. As the air flows through the evaporative unit 134, it comes in contact with progressively colder lines of refrigerant, thus being cooled to the coldest temperature reached by evaporating refrigerant. By utilizing an opposing direction flow, both the refrigerant and the air may achieve maximum temperature change without sacrificing SEER efficiency.

The opposing direction, evaporative unit 134 may comprise coils designed to facilitate transfer heat from the airflow to the refrigerant via the opposing direction flow by directing the two flows, the airflow and the refrigerant, in opposing directions or substantially opposite directions and maintaining the two flows in thermally conductive contact. In many embodiments, the opposing direction, evaporative unit 134 can maintain a nearly constant gradient between the two flows over their entire length. With a sufficiently long length and a sufficiently low flow rate, maintaining a nearly constant gradient between the two flows can result in an air exit temperature at or near the temperature of the incoming refrigerant. Thus, if the incoming refrigerant is at or near freezing, i.e., 0° C., the airflow exiting the opposing direction, evaporative unit 134 may be at or near freezing even though the exiting refrigerant is close to the temperature of the incoming room temperature air.

In many embodiments, the refrigerant cycle of A/C system 100 is designed to reduce the outgoing airflow to a temperature between 32° F. and 40° F. Some embodiments are designed to reduce the temperature to less than 55° F. Other embodiments are designed to reduce the temperature to less than 50° F. Further embodiments are designed to reduce the temperature to less than 45° F. Some embodiments are designed to reduce the temperature to less than 40° F. Further embodiments are designed to reduce the temperature to less than 35° F. And several embodiments are designed to reduce the temperature to about 32° F.

In some embodiments, the opposing direction, evaporative unit 134 directs the flows of the refrigerant and air in opposite directions in a thicker cooling coil than standard evaporative coils for A/C systems. The thicker cooling coils coupled with variable speed air flow from the variable air unit 132 may achieve full transfer of the cooling from the refrigerant to the air and simultaneously achieve a near freezing exit air temperature; thus removing more moisture from the air than standard A/C systems. Some embodiments may be least effective in extremely low humidity environments, such as Phoenix or Las Vegas and most effective in Southeast U.S.A. where lowering humidity is a more cost effective method of achieving a comfortable environment than temperature reduction alone.

In several embodiments, the moisture from the airflow may be deposited as ice on the opposing direction, evaporative unit 134. In such embodiments, the A/C controller 140 may cycle the compressor 116 on and off to maintain a layer of ice on the opposing direction, evaporative unit 134, which is thin enough to allow the airflow. In other embodiments, the A/C controller 140 may control the airflow rate through the opposing direction, evaporative unit 134 to prevent ice from forming on the opposing direction, evaporative unit 134. In many embodiments, a substantially freezing temperature of the exit air may be achieved by switching between fast and slow airflow rates, the switching frequency being fast enough to maintain air exit temperature within a relatively narrow and acceptable band. Further embodiments comprise an override temperature sensor 137 or other ice detection sensor, which speeds up the air flow across the coils if the coldest parts of the coils begin to freeze. The override temperature sensor 137 may reside on or near the evaporative unit 134.

In some embodiments, the compressor 116 may comprise a variable speed compressor and A/C controller 140 or logic of control panel 118 may control the speed of the compressor 116. Such embodiments may reduce the speed of the compressor 116 to adjust the refrigeration cycle to de-ice the evaporative unit 134 or to avoid ice build-up or additional ice build-up on evaporative unit 134. Furthermore, the compressor 116 speed or on/off setting may be calculated from a combination of wet bulb and dry bulb temperature. For instance, the A/C controller 140 may reduce the speed of compressor 116 periodically and/or based upon input from a sensor such as the temperature sensor 135 or the override temperature sensor 137.

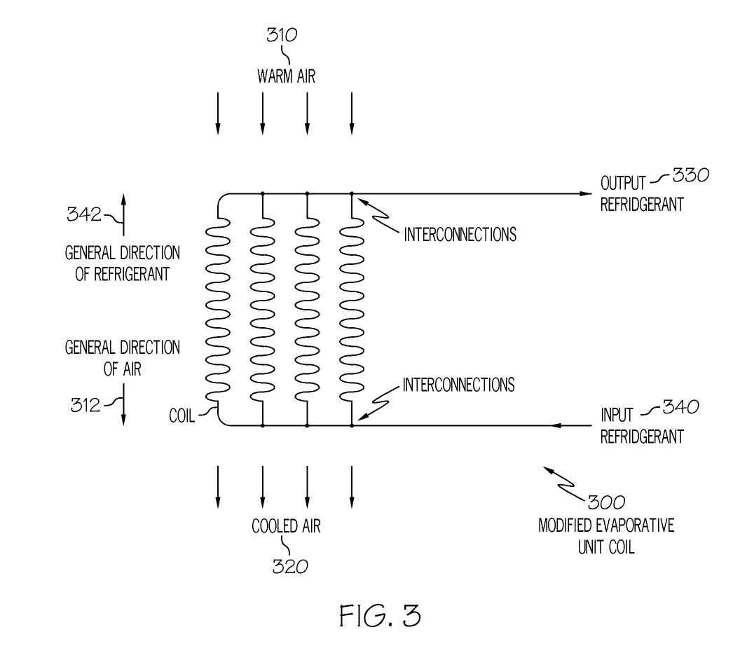

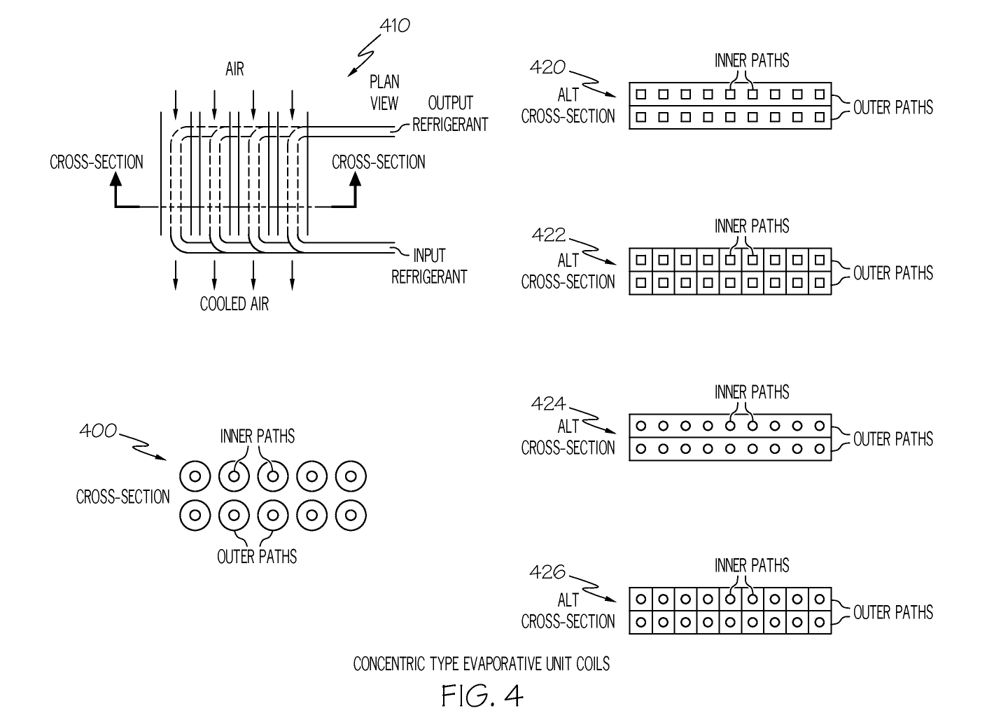

The opposing direction, evaporative unit 134 may comprise arrangements such as those illustrated in FIG. 3 or 4 or other similar arrangements to cause an opposite direction heat exchange between the airflow and the refrigerant.

The A/C controller 140 may comprise controller logic 142 as well as inputs and outputs and a user interface to receive information from a user regarding how to control the ambient room temperature or the sensed or perceived temperature based upon the actual ambient temperature in a conditioned room and the humidity. In some embodiments, the A/C controller 140 may comprise a processor-based controller or other intelligent/sophisticated controller to maintain the exit air temperature of evaporative unit 134. In one embodiment, air conditioner controller 140 may maintain the exit air temperature of evaporative unit 134 close to freezing by one or more or all of the following functions: adjusting the airflow rate through the opposing direction evaporator coil; increasing the airflow rate in response to an instruction to increase humidity; reversing the airflow direction through the opposing direction coil to increase humidity; cycling between fast and slow airflow rates; cycling between forward and reverse airflow directions through the opposing direction evaporator coil; cycling the compressor on and off to freeze and melt ice to maintain an air exit temperature from the evaporator coil at or close to 0° C.; to vary fan speed or louver position; which in-turn varies air-flow rate, and where zero may be one of the settings; switching between fast and slow airflow rates, the switching frequency being fast enough to maintain air exit temperature within a relatively narrow and acceptable band; setting the temperature of evaporation of the cooling fluid close to 0° C. so as to avoid ice build up on the evaporator coil while maintaining the ability to cool air to close to freezing temp; and setting the temperature of evaporation of the refrigerant close to 0° C. with sufficient thermal gradient/resistance between air and refrigerant to work at roughly −2° C. to +6° C. for the boiling temperature of the liquid refrigerant in the evaporator coil.

In some embodiments, the controller logic 142 can calculate an enthalpy setting based upon an input temperature from a user. The controller logic 142 may comprise hardware, code, or a combination of hardware and code such as a processor and memory for executing software or firmware. The A/C controller 140 may be settable to maintain a user specified temperature and user specified humidity, a user specified wet bulb temperature or in-between-point between the wet and dry bulb temperature or the A/C may simply dehumidify as much as it can and the user will set only the temperature.

In some embodiments, the A/C controller 140 controls power to the compressor 116, just as for a standard A/C. Some embodiments may comprise an air-conditioning system 100 where a multi-position or infinitely variable controller is utilized to vary airflow via the variable air unit 132 by varying the fan speed or louver position. The airflow may range from none to the maximum available via the variable air unit 132.

In several embodiments, ice is allowed to accumulate in the evaporative unit 134 and then either the airflow rate is increased or the compressor 116 is slowed or turned off to allow the ice to melt. This cycle is repeated, such that air contact with ice maintains air exit temperature at or close to 0° C. In some embodiments, the airflow rate is increased, and/or the airflow direction is reversed with regard to the refrigerant flow direction through the evaporative unit 134 when a higher humidity is desired. In further embodiments, the airflow can be switched from the increased dehumidification configuration to a standard configuration so that room humidity can be lower than the standard humidity or at the standard humidity.

Some embodiments may comprise an evaporative unit where the liquid refrigerant enters at or near the bottom of the evaporative unit and air enters from the top so that gravity helps keep the liquid refrigerant in the last coils the air passes by and so that the first coils the incoming air passes by are mostly gas filled.

Note that the refrigerant (or coolant) refers to the fluid that is used to implement the refrigeration cycle. Other implementations may use other fluids, including, ammonia, flammable fluid, water or water with antifreeze and/or anti-rust additives.

### Evaporator Units

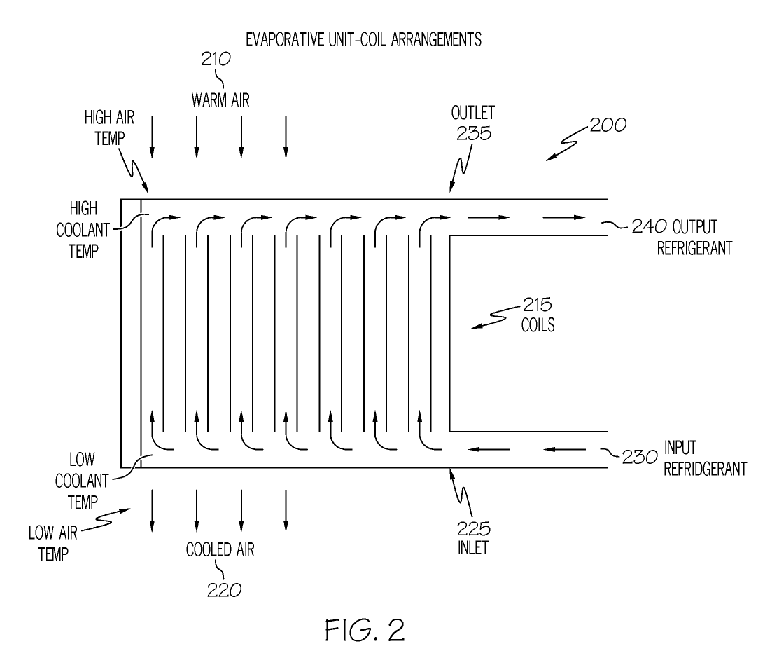

FIG. 2 shows an embodiment of an evaporator coil 200 such as the opposing direction, evaporative unit 134 of FIG. 1. The evaporator coil comprises a medium such as copper and/or other thermally conductive material(s). Warm air 210 enters the evaporator coil 200 at the end of the coil at which the refrigerant exits, output refrigerant 240 via refrigerant outlet 235. Outlet 235 is generally the coupling, joint, or interconnection between an outgoing refrigerant line and the evaporator coil 200, which may be a fitting, a welded joint, or the like. The temperatures of the air and the refrigerant are at the highest temperature with respect to their other temperatures within the evaporative coil 200. The air is directed in the opposite direction of the refrigerant and exits at cooled air 220. The cooled air 220 may exit at or near freezing, or near the temperature of the input refrigerant 230 via refrigerant inlet 225. The refrigerant inlet 225 is generally the coupling, joint, or interconnection between the incoming refrigerant line and the evaporator coil 200. Both the input refrigerant 230 and the cooled air 220 are at their lowest temperature (within the coil 200).

FIG. 3 illustrates a modified evaporative coil 300. The modified evaporative coil 300 is a standard evaporative coil that has been adjusted or reworked to provide opposing flows of air and refrigerant. In particular, while the refrigerant may also flow left to right, the general direction or progression of the refrigerant 342 is substantially opposite the general direction of the air 312 and thus are referred to as opposing flows. The modified evaporative coil 300 has the input warm air 310 entering where the output refrigerant 330 exits the coil 300 and the cooled air 320 exits at the entrance of the input refrigerant 340. Note that in many embodiments, the number of coils varies and that the illustration of four coils interconnected by six interconnections will vary between embodiments.

In many embodiments, the coils or other evaporative units are four or more layers deep and the refrigerant flows in the opposite direction of the air. Total airflow may be roughly half of a standard design so the coil face may be roughly half as much. In other embodiments, multiple layers of parallel coils may reside on top of one another and be interconnected to transfer the refrigerant in parallel from the cooled air end to the warm air end. For instance, four more coils may reside below the coils illustrated in FIG. 3 with sufficient air space to facilitate a parallel air flow between the upper and lower sets of coils. The coils may optionally comprise “micro tubing” for the flow of coolant.

FIG. 4 shows alternate embodiments of the opposing direction, evaporative comprising coils. Cross-section 400 illustrates concentric cylindrical paths for refrigerant and airflows. For example, the inner paths may contain refrigerant and the outer paths may contain air, or vice versa. Plan view 410 illustrates a plan view of concentric type evaporative coils. Note that the numbers of rows and layers shown is for illustration purposes because embodiments may implement any number of rows and layers, which may depend upon the available space as well as the amount of refrigerant and air that will flow through the paths. Note also that the size of the paths with respect to one another may vary depending upon the determined flow of air and refrigerant for efficient transfer of heat from the air to the refrigerant over a given length of the coils.

Alternative cross-sections 420, 422, 424, and 426 illustrate different configurations for opposing direction, evaporative coils.

Some embodiments may comprise a method for creating a design for manufacturing of an opposing direction, evaporator unit. The process may comprise generating a schematic for interconnecting coils having one general direction of flow from a first end of each of the coils to a second end of each of the coils. Interconnecting may comprise coupling the first end of each of the coils with an inlet coupling and coupling a second end of each of the coils with an outlet coupling to facilitate flow of refrigerant through the first end of each of the coils to the second end of each of the coils. The process may also comprise generating a schematic for mounting the coils in a frame to create the opposing direction evaporator coil unit with interconnections of the schematic for interconnecting the coils.

Some embodiments may comprise a method for creating a design for manufacturing of an opposing direction evaporator coil unit. The method may comprise generating a schematic for interconnecting coils having one general direction of flow from a first end of each of the coils to a second end of each of the coils. Interconnecting may comprise coupling the first end of each of the coils with an inlet coupling and coupling a second end of each of the coils with an outlet coupling to facilitate flow of refrigerant through the first end of each of the coils to the second end of each of the coils. The method may also comprise generating a schematic for mounting the coils in a frame to create the opposing direction evaporator coil unit with interconnections of the schematic for interconnecting the coils.

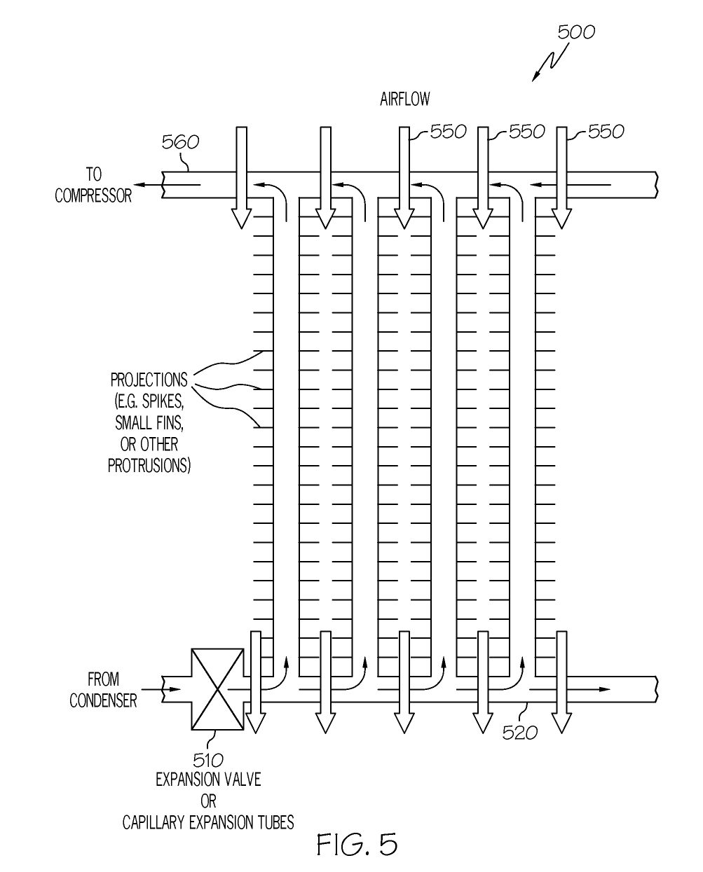

FIG. 5 illustrates another embodiment of the opposing direction, evaporative unit 500. Note that the term “evaporative unit” is used generically to describe an arrangement to transfer energy from the airflow 550 to the refrigerant received from condenser coils. Note also that the numbers of rows, such as the four tubes shown, and vertically arranged layers of such rows may be arranged in any number of rows and layers for different embodiments based upon, e.g., the available space as well as the amount of refrigerant and airflow 550. Cover plates (not shown) may also cover the outside of the tubes 530 to channel the airflow 550 across the tubes 530 and through the projections 540.

The refrigerant flows from condenser coils through an expansion valve 510 into a distribution tube 520 via an inlet coupling (not shown). In some embodiments, couplings between tubing may be welded in lieu of using a fitting. The distribution tube 520 distributes the refrigerant into tubes 530 to in a direction that is substantially opposite the direction of the airflow 550 to a collection tube 560. In other words, the evaporative unit 500 comprises tubes with projections to direct refrigerant in a direction opposing the direction of the airflow to accomplish an opposing direction, heat exchange between the airflow and the refrigerant flowing through the tubes. The refrigerant in the collection tube 560 returns to a compressor. Each of the tubes 530 comprises projections 540 to enhance transference of heat between the airflow 550 and the refrigerant. In the present embodiment, the projections 540 comprise fins. In other embodiments, the projections 540 may comprise spikes, other types of projections, or a combination of more than one type of projections. In some embodiments, the refrigerant can pass through the projections and, in other embodiments, the refrigerant does not pass through the projections. In the latter embodiments, the projections may be designed to enhance heat exchange between the refrigerant within the tube and the airflow by conducting heat through the projection and through the tube to the refrigerant. The projections may be solid or hollow and may comprise one or more materials designed to enhance heat exchange.

The projections 540 increase the surface area of contact between the airflow 550 and the tubes 530 to increase the rate at which heat can be transferred between the airflow 550 and the refrigerant. In many embodiments, the projections 540 are designed to minimize the increase in resistance to air flow through evaporative unit 500 while maximizing the surface area of contact between the airflow 550 and the projections 540.

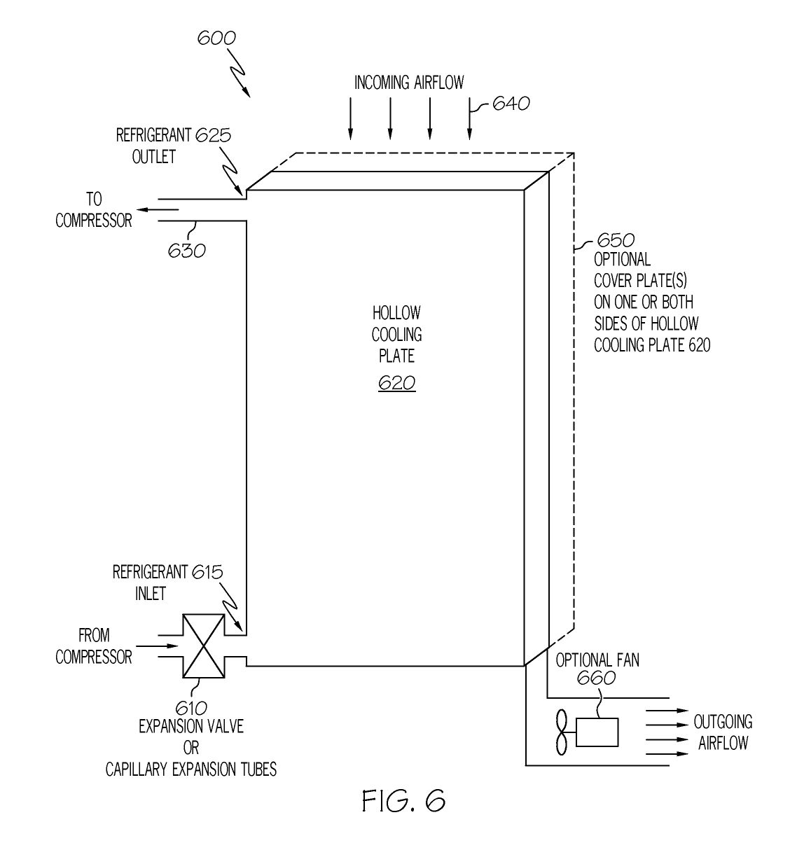

FIG. 6 illustrates another embodiment of the opposing direction, evaporative unit 600. Although one hollow plate 620 is shown, multiple plates can be arranged vertically, one above the other, or side by side, or a combination thereof. Further embodiments include one or more cover plates to direct airflow along a path across the hollow plate 620. When multiple plates such as plate 620, are vertically aligned, cover plates 650 may be arranged on the outside of the arrangement of plates to direct airflow 640.

The refrigerant flows from condenser coils through an expansion valve 610 into the bottom of the hollow plate 620 via refrigerant inlet 615. The hollow plate 620 distributes the refrigerant across the length of the hollow plate 620 and the refrigerant flows upward to a tube 630 or output refrigerant line via refrigerant outlet 625 and back to a compressor. The flow of the refrigerant is generally opposite the direction of airflow 640. An optional fan 660 may regulate the rate of the airflow 640 and direct the airflow 640 into a conditioned space. In some embodiments, the airflow 640 is caused by the decrease in temperature and increase in density of the air of the airflow 640, which causes the air to fall down across the plate 620 without the optional fan 660.

### Variable Air Units

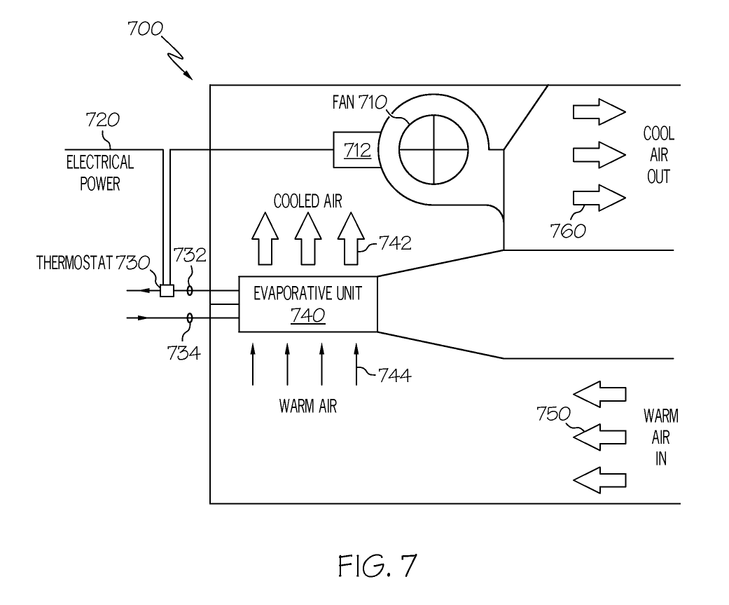

FIG. 7 shows an embodiment of an air-handling cabinet 700, such as the indoor unit 130 of FIG. 1, designed to achieve variable speed airflow by use of a variable speed fan 710. In some embodiments, the variable speed fan 710 may comprise a direct current (DC) motor and circuitry coupled with the DC motor to vary the speed of rotation of the motor or an alternating current (AC) motor and circuitry coupled with the AC motor. In some embodiments, the circuitry may include an air speed controller to control the speed of rotation of the motor based upon input from one or more sensors. In other embodiments, the circuitry may control the speed of the fan motor based upon input from another controller such as an A/C controller.

In FIG. 7, a thermostat 730 (or temperature sensor) may couple with the output refrigerant line 732 to monitor the temperature and the signal may be transmitted to the air speed controller 712 for the fan 710 directly or to a controller logic such as controller logic 142 in FIG. 1.

Warm air 744 enters the cabinet 700 at warm air in 750 and traverses across evaporative unit 740. Evaporative unit 740 may comprise an opposing direction, evaporative unit such as unit 134 of FIG. 1. Or evaporative unit 740 may comprise a standard evaporative coil. Input refrigerant line 734 directs refrigerant through the evaporative unit 740 and through output refrigerant line 732. Thermostat 730 couples with the output refrigerant line 732 to monitor the temperature of the outgoing refrigerant. The thermostat 730 may attach to the exterior of the output refrigerant line 732 or may be inline with the output refrigerant 732 to measure the temperature of the refrigerant. In some embodiments, the thermostat 730 may comprise a resistive type measuring device or a capacitive-type measuring device.

Electrical power 720 supplies power to thermostat 730 to determine the temperature of the refrigerant and powers the air speed controller 712. In some embodiments, the thermostat 730 may provide an absolute temperature and, in other embodiments, the thermostat 730 may provide a temperature signal indicative of the difference between the temperature of the refrigerant in the output refrigerant line 732 and the input refrigerant line 734. In further embodiments, the thermostat 730 may provide a signal indicative of the temperature of the output refrigerant line 732 with respect to a threshold temperature such as the ambient or room temperature or the temperature of the warm air 744.

The air speed controller 712 may adjust the speed of the airflow through the coils to achieve a particular temperature from the thermostat 730 or for the refrigerant in the output refrigerant line 732. The air speed controller 712 may adjust the speed of the airflow by increasing the RPMs of the fan 710 in response to an indication that the temperature of the refrigerant is lower than a threshold temperature and decreasing the RPMs in response to an indication that the temperature of the refrigerant is higher than a threshold temperature. Many embodiments employ hysteresis or a delay to avoid continuous adjustments to the speed of the fan 710 while the temperature of the refrigerant is near the threshold temperature for the refrigerant in the output refrigerant line 732.

FIG. 8 shows an embodiment of an air-handling cabinet 800, such as the indoor unit 130 of FIG. 1, for achieving variable speed flow by use of a bypass louver 830. In particular, a fixed speed fan 810 draws air through an evaporative unit 820 from the warm air in 840 and the bypass louver 830 operates in parallel with the evaporative unit 820 to allow airflow to bypass the evaporative unit 820. The cool air out 850 remains at the constant speed caused by the fan but the airflow through the evaporative unit 820 is inversely proportional to the airflow through the bypass louver 830. Thus, the granularity of the speed with which the warm air flows through the evaporative unit 820 is based upon the granularity with which the bypass louver 830 can reposition to increase or decrease airflow through the bypass louver 830.

In many embodiments, evaporative unit 820 may comprise an opposing direction, evaporative unit. The opposing direction, evaporative unit may comprise coils, tubes, tubes with projections, hollow plates, or a combination thereof. In some embodiments, opposing direction, evaporative unit may comprise a standard A/C evaporative coil and an opposing direction, evaporative unit coupled in series or in parallel. In some of these embodiments, the louver arrangement illustrated may be replaced with walls to force or channel the airflow through the evaporative unit 820.

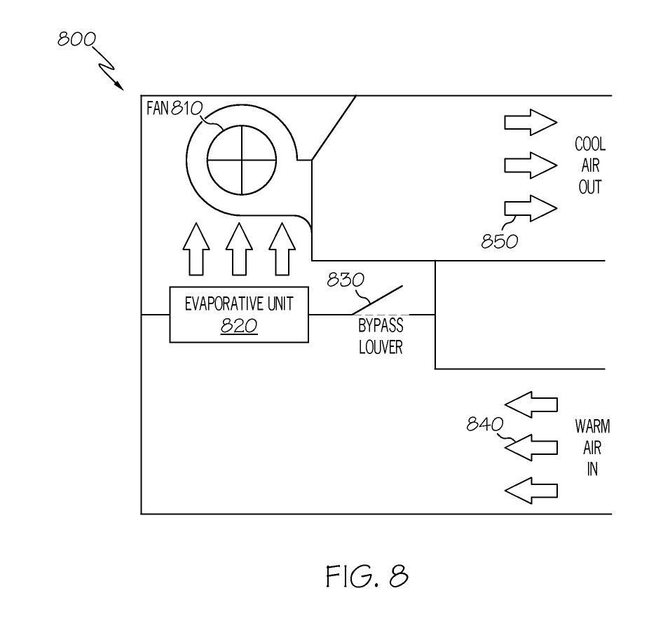

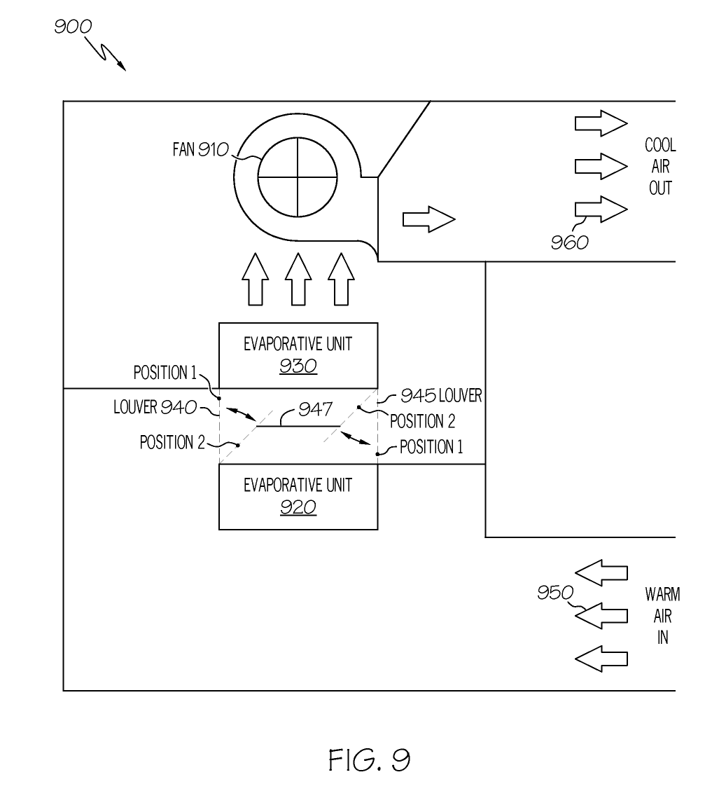

FIG. 9 shows an embodiment of air-handling cabinet 900, such as the indoor unit 130 of FIG. 1, for achieving variable speed flow by use of louvers 940 and 945. The louver design of the present embodiment achieves not only variable speed flow through the evaporative units 920 and 930 but also allows for the incremental change-over from evaporative units 920 and 930 in series to evaporative units 920 and 930 in parallel. This allows for adjustable air temperature drop in the evaporative units 920 and 930 for control of room humidity.

Warm air enters cabinet 900 at warm air in 950, flows across evaporative units 920 and 930 and exits through cool air out 960 at a speed determined by fan 910. In some embodiments, fan 910 may be a fixed speed fan and, in other embodiments, fan 910 is a variable speed fan.

The speed with which the warm air flows across evaporative units 920 and 930 is based upon the positioning of the louvers 940 and 945. Louvers 940 and 945 may be interconnected by interlink 947. Interlink 947 coordinates movement of the louvers 940 and 945 such that they can incrementally move from a position 1 through position 2 to a third position at which louvers 940 and 945 interconnect to substantially block air exiting evaporative unit 920 from entering evaporative unit 930. Movement of the louvers 940 and 945 incrementally change the air flow through evaporative units 920 and 930 from air flow through the evaporative units 920 and 930 in series to at position 1 to air flow through the evaporative units 920 and 930 in parallel. In particular, at position 1, airflow is blocked so that the air can only flow from warm air in 950 through evaporative unit 920 and then through evaporative unit 930. On the other hand, while the louvers 940 and 945 are interlocked to substantially block air exiting evaporative units 920 from entering evaporative unit 930, the louvers 940 and 945 allow airflow around evaporative units 920 to go through evaporative unit 930. In some embodiments, interlink 947 may comprise a coupling to interconnect an end of louver 940 with an end of louver 945 to substantially block air exiting evaporative units 920 from entering evaporative unit 930.

In many embodiments, evaporative unit 930 may comprise an opposing direction, evaporative unit and evaporative unit 920 may comprise an opposing direction, evaporative unit. The opposing direction, evaporative units may comprise coils, tubes, tubes with projections, hollow plates, or a combination thereof. In some embodiments, air-handling cabinet 900 is a retrofitted air-handling cabinet or evaporative unit. In such embodiments, evaporative unit 930 may comprise a standard A/C evaporative coil and evaporative unit 920 may comprise an opposing direction, evaporative unit, or vice versa. In some of these embodiments, the louver arrangement illustrated may be replaced with walls to force or channel the airflow through the two evaporative units in series or in parallel.

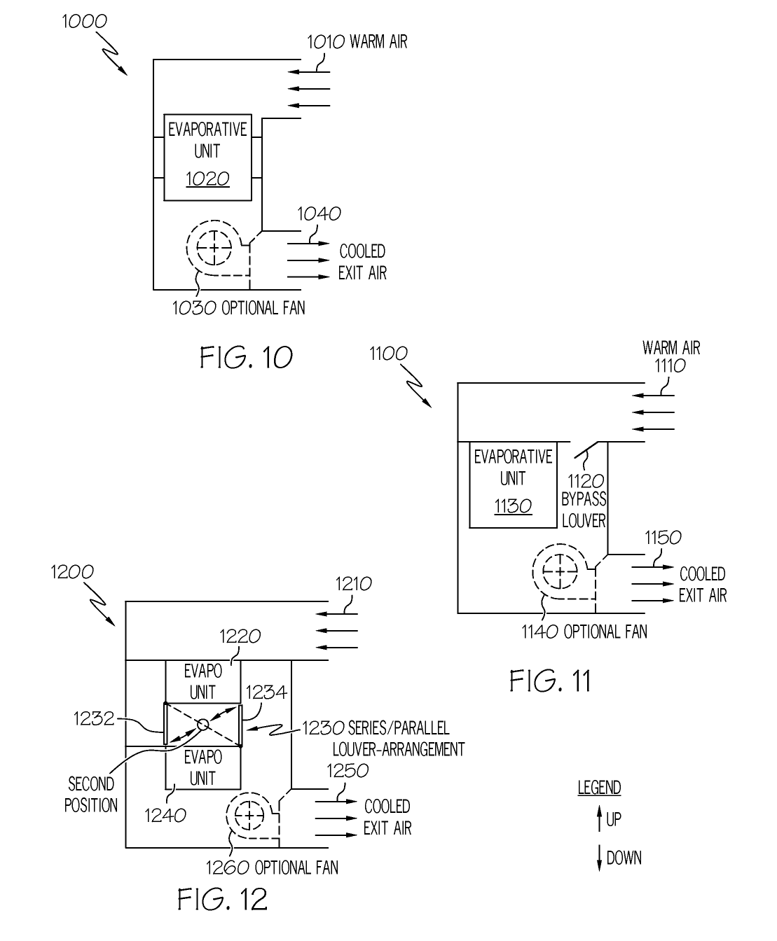

FIGS. 10-12 show embodiments of air-handling cabinets such as indoor unit 130 of FIG. 1 that use the higher density of colder air to create all or most of the airflow past the evaporative unit. In these embodiments, note that the warm air is received from a greater height than the height of the exiting cooled air. This arrangement takes advantage of the fact that colder air is denser than warm air. Thus, as the warm air is cooled, the air increases in density and falls through the evaporative units. At the same time, the increased density of the cooled air as well as the movement of the denser air from the upper side of the cabinet to the lower side of the cabinet causes the cabinet to capture or pull in warm air. This creates a natural airflow through the evaporative units eliminating or reducing the need to force air through the cabinet with a fan. Some of these embodiments are used in conjunction with a multi-speed compressor, which adjusts the cooling of the evaporative coils and thus affects the rate at which the warm air is cooled.

FIG. 10 shows an embodiment of a cabinet 1000, such as the indoor unit 130 of FIG. 1, comprising evaporative unit 1020 and an optional fan 1030. In many embodiments, evaporative unit 1020 may comprise an opposing direction, evaporative unit. The opposing direction, evaporative unit may comprise coils, tubes, tubes with projections, hollow plates, or a combination thereof. In some embodiments, opposing direction, evaporative unit may comprise a standard A/C evaporative coil and an opposing direction, evaporative unit coupled in series or in parallel.

Warm air 1010 enters cabinet 1000 at an upper side of the cabinet 1000, flows across evaporative unit 1020 and exits through cooled exit air 1040 at a speed determined by the difference in temperature between the warm air 1010 and cooled exit air 1040. Some embodiments comprise the optional fan 1030, which comprises a fixed speed fan or a variable speed fan, to enhance control over the speed of the airflow across evaporative unit 1020.

FIG. 11 shows an embodiment of a cabinet 1100, such as the indoor unit 130 of FIG. 1, comprising a bypass louver 1120, an evaporative unit 1130, and an optional fan 1140. Warm air 1110 enters cabinet 1100, flows in parallel through bypass louver 1120 and across evaporative unit 1130, and exits through cooled exit air 1150 at a speed determined by the difference in temperature between the warm air 1110 and cooled exit air 1150. The bypass louver 1120 can be adjusted from a closed position, which blocks air from bypassing the evaporative unit 1130 through bypass louver 1120, to a fully open position, which allows airflow through the bypass louver 1120 and the evaporative unit 1130 in parallel based upon the resistances to airflow through the bypass louver 1120 and the evaporative unit 1130. Some embodiments comprise the optional fan 1140, which comprises a fixed speed fan or a variable speed fan, to enhance control over the speed of the airflow across evaporative unit 1130.

In many embodiments, evaporative unit 1130 may comprise an opposing direction, evaporative unit. In some embodiments, opposing direction, evaporative unit may comprise a standard A/C evaporative coil and an opposing direction, evaporative unit coupled in series or in parallel with respect to the airflow.

FIG. 12 shows an embodiment of a cabinet 1200, such as the indoor unit 130 of FIG. 1, comprising an evaporative unit 1220, a series/parallel louver arrangement 1230, an evaporative unit 1230, and an optional fan 1240. Warm air 1210 enters cabinet 1200, flows in series, in parallel, or partially in series and partially in parallel series/parallel louver arrangement 1230 and exits through cooled exit air 1250. As illustrated, the louver arrangement 1230 comprises two louvers 1232 and 1234 that transition from the first position shown, which forces warm air 1210 through evaporative unit 1220 and evaporative unit 1240 in series, and a second position indicated by the dashed lines. In the first position for the louvers 1232 and 1234, louver 1232 blocks air from entering directly into evaporative unit 1240 from the inlet of warm air 1210. In the second position, the louvers 1232 and 1234 allow warm air 1210 to cross evaporative unit 1220 and the louvers 1232 and 1234 operate in conjunction to prevent the air from entering evaporative unit 1240 and force the air to exit as cooled exit air 1250 without crossing evaporative unit 1240. Similarly, the louvers 1232 and 1234 prevent air that exits evaporative unit 1220 from entering evaporative unit 1240 and force that air to exit as cooled exit air 1250.

In some embodiments, the louvers 1232 and 1234 are interlinked mechanically, electrically, or logically. In other embodiments, the louvers 1232 and 1234 operate independently. In further embodiments, the louvers 1232 and 1234, individual or in cooperation, can be moved incrementally from the position illustrated to the second position and from the second position to the position illustrated.

In many embodiments, evaporative units 1220 and 1230 may comprise opposing direction, evaporative units. In some embodiments, evaporative unit 1220 may comprise a standard A/C evaporative coil and evaporative unit 1230 may comprise an opposing direction, evaporative unit, or vice versa.

### A/C Controllers

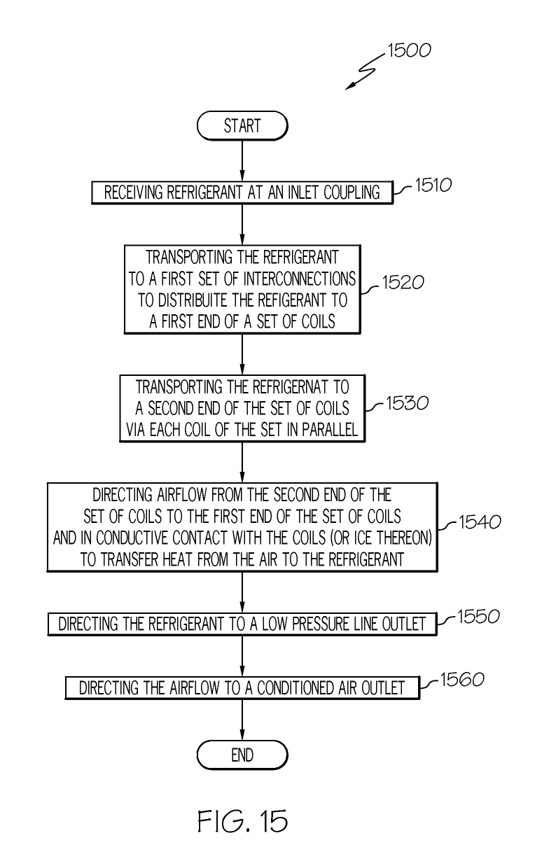

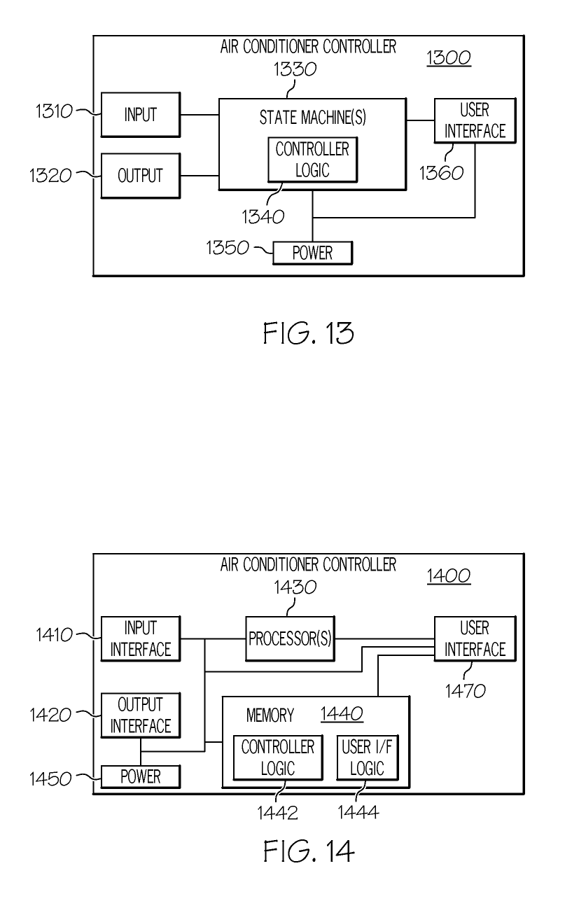

FIG. 13 illustrates an A/C controller 1300 comprising an input 1310 to receive sensor data such as the temperature of the airflow exiting and/or entering an opposing direction, evaporative unit or a refrigerant temperature exiting and/or entering the opposing direction, evaporative unit. The A/C controller 1300 comprises an output to output signals to adjust airflow through a opposing direction, evaporative unit via a variable air unit, a power source 1350, a user interface 1360 to receive input from a user related to conditioning air of a conditioned space, and state machine(s) 1330.

State machine(s) 1330 may comprise one or more specific purpose circuits to implement controller logic 1340 in hardware. Controller logic 1340 may control a variable air unit to maintain a temperature at the exit of the opposing direction, evaporative units at or near freezing. For example, controller logic 1340 may adjust the speed of airflow through the units by adjusting the speed of a variable speed fan or by adjusting the positioning of one or more louvers. In some embodiments, controller logic 1340 may determine an adjustment to adjust the positioning of a bypass louver to increase or decrease the airflow through units. Determining an adjustment for the bypass louver may involve calculating a change in air speed and determining the adjustment to the bypass louver to implement the change in air speed. In other embodiments, the controller logic 1340 may incrementally open or close the bypass louver to reduce or increase the airflow across the units until the desired refrigerant temperature in the output refrigerant line from the units is achieved.

In other embodiments, the controller logic 1340 may incrementally change the positioning of louvers inside an indoor unit toward parallel airflow through the units or toward airflow through the units in series until a threshold temperature or humidity level is reached. In such embodiments, the A/C controller 1300 may receive input from a humidity sensor measuring the humidity in the air-conditioned space such as humidity sensor built into A/C controller 1300.

FIG. 14 illustrates another embodiment of an A/C controller 1400 such as A/C controller 140 in FIG. 1. A/C controller 1400 comprises input interface 1410 to receive and transform inputs from sensors for input to processor(s) 1430. Output interface 1420 transforms outputs from processor(s) 1430 to control devices such as a compressor and a variable air unit and memory 1440 comprises controller logic 1442 and user interface logic 1444 in the form of code. User interface logic 1444 may comprise logic to determine an enthalpy or wet bulb setting based upon an input temperature from user interface 1470 as well as sensor data from input interface 1410. User interface logic 1444 may alternatively comprise logic to control the temperature or sensed temperature based upon a temperature input from the user interface 1470 and the humidity level in the conditioned space via a humidity sensor coupled with input interface 1410. In some embodiments, the humidity sensor may be part of A/C controller 1400.

### Processes

FIG. 15 illustrates an embodiment 1500 of a flow chart for a process implemented by opposing direction, evaporative coils such as the opposing direction, evaporative units in FIGS. 2-6. Embodiment 1500 begins with receiving refrigerant at an inlet coupling (element 1510). The inlet coupling may be a fitting or other joint to join incoming refrigerant lines to another line or device. The joint may be glued welded, sealed, or connected in such a way as to prevent refrigerant from escaping at the joint.

The refrigerant may be near 32° F. when entering the opposing direction, evaporative coils and may be composed of a combination of liquid and gas forms of the refrigerant. It is mostly liquid when entering the evaporative coils and is or is substantially 100% gas when leaving the evaporative coils.

After entry, the opposing direction, evaporative coils transport or direct the refrigerant to a first set of interconnections to distribute the refrigerant to a first end of a set of coils (element 1520). Cooled air received from a warm air inlet (the inlet from the air conditioned space or from outside of the air conditioned space) may be exiting the indoor unit that contains the opposing direction, evaporative coils into distribution air ducts near the first set of interconnections.

The set of coils transport the refrigerant to a second end of the set of coils via each coil in the set of coils in parallel (element 1530). At the same time, the indoor unit directs airflow from the second end of the set of coils to the first end of the set of coils while maintaining the airflow in thermally conductive contact with the coils (or ice thereupon) to transfer heat from the air to the refrigerant (element 1540). In some embodiments, the opposing direction, evaporative coils may be designed to accommodate ice buildup on the set of coils by having sufficient space for the airflow around or over the ice buildup to avoid significant blockage of the airflow. In many of these embodiments, the coils may coils may be periodically defrosted or de-iced. In other embodiments, a thin layer of ice is maintained on the set of coils near the entry of the refrigerant. In further embodiments, the opposing direction, evaporative coils are not designed for ice buildup and may maintain a temperature just above freezing to avoid ice buildup.

After flowing through a second set of interconnections at the second end of the set of coils, the opposing direction, evaporative coils directs the refrigerant into a low pressure refrigerant line outlet (element 1550). In many embodiments, the temperature of the refrigerant is measured at or near this outlet of the evaporative unit to determine whether sufficient heat exchange occurred between the refrigerant and the air while traversing the set of coils. In some embodiments, a signal is transmitted to a controller for a variable speed fan to adjust the speed of the fan based upon the temperature of the refrigerant at the outlet. In further embodiments, the temperature sensor for the refrigerant is some distance away from the outlet along the refrigerant line between the outlet and the compressor in the outdoor unit.

The indoor unit also directs the airflow from the first end of the coils to a conditioned air outlet (element 1560) where the conditioned air may exit into the conditioned space or enters a set of air distribution ducts to distribute to different areas of the conditioned space. In some embodiments, the airflow is directed across the coils to transfer heat from the air to the refrigerant via thermally conductive materials from which the coil is made, to reduce the airflow to less than 55° F. while crossing the coil. In several embodiments, the airflow is directed across the coils to reduce the airflow to less than 45° F., less than 40° F., or less than 35° F. while crossing the coil. In further embodiments, airflow is directed across the coil to reduce the airflow to approximately 32° F. while crossing the coil but above freezing to avoid ice buildup. In other embodiments, airflow is directed across the coil to reduce the airflow to approximately 32° F. while crossing the coil and while directing the airflow about ice buildup on the coil.

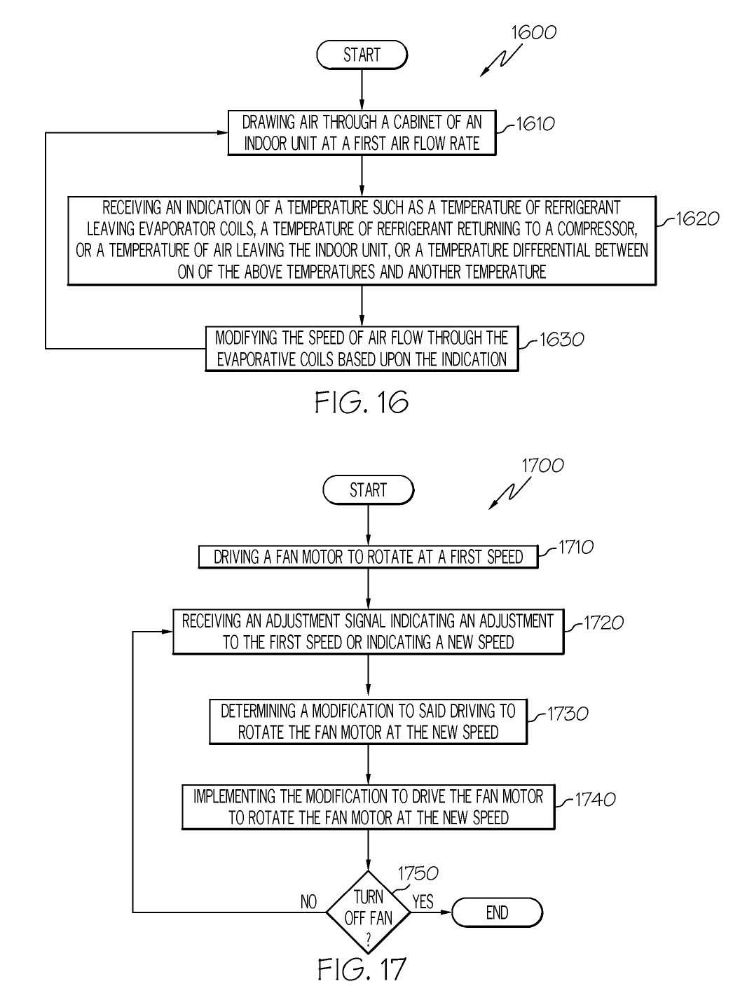

FIG. 16 illustrates an embodiment 1600 of a flow chart for a variable air unit of an indoor unit such as the variable air unit in FIG. 1. Embodiment 1600 begins drawing air through a cabinet of an indoor unit of an A/C system at a first flow rate (element 1610). The indoor unit may comprise a fan to draw air into the unit from the air-conditioned space or from outside of the air-conditioned space such as air from outside of a building. In some embodiments, the fan may be a fixed rate fan and in other embodiments, the fan may be a variable speed fan.

The variable air unit may receive an indication of a temperature or temperature differential such as a temperature of a refrigerant leaving evaporative coils of the indoor unit, a temperature of refrigerant returning to a compressor in an outdoor unit, a temperature of air leaving the indoor unit or exiting distribution ducts of the indoor unit, or a temperature differential between one or more of the above temperatures and another temperature such as the ambient temperature of the air-conditioned space or an ambient temperature of incoming warm air (element 1620). For example, the variable air unit may receive the temperature of the cooled air leaving the indoor unit and compare the temperature to the temperature of the ambient temperature of the air-conditioned space. Based upon the difference, the variable air unit may adjust the airflow across the evaporative coils in the indoor unit (element 1630).

In further embodiments, an override sensor may monitor the coils for ice and transmit a signal to the variable air unit or logic associated with the variable air unit to indicate that the airflow should be increased to avoid or attenuate freezing precipitation on the coils.

FIG. 17 illustrates an embodiment 1700 of a flow chart for a variable air unit comprising a variable speed fan such as the variable speed fan in FIG. 7. Embodiment 1700 begins with driving a fan motor to rotate at a first speed (element 1710). At steady state, the fan motor may continuously run or may turn on periodically.

A sensor such as a temperature sensor for an outgoing refrigerant line from the evaporative coils may monitor the temperature of the refrigerant and transmit a continuous or periodic adjustment signal to logic to control the speed of airflow across the evaporative coils. In some embodiments, the adjustment signal may transmit in response to a change in temperature sensed by the temperature sensor. In further embodiments, the sensor may include hysteresis to avoid transmitting the adjustment signal without some threshold of change in the monitored temperature of the refrigerant line. In other embodiments, the temperature sensor may monitor the temperature of the refrigerant at the compressor in the outdoor unit or the temperature of the out going air from the indoor unit.

Upon receipt of the adjustment signal(s) (element 1720), if multiple signals are received, the logic may average or weight the results to determine if and how much adjustment to the airflow is indicated by the adjustment signal(s). In the present embodiment, the logic may determine a modification to the driving of the fan to rotate the fan motor at a new speed (element 1730). For instance, the temperature of the refrigerant at the compressor may be at a higher temperature threshold for the refrigerant so the logic may determine that the airflow should be increased. In some embodiments, depending upon the rate of increase in the temperature, the airflow may be decreased via different amounts. Thus, if the temperature is rising at a relatively high rate, a relatively large decrease in fan speed may be implemented. In other embodiments, the steps to increase or decrease the airflow may be fixed.

In other embodiments, a humidity sensor may generate the adjustment signal. The humidity sensor may couple with the warm air in, the cooled air out, or both. In further embodiments, the humidity sensor may be located on the A/C controller or otherwise located in the air-conditioned space. In response to an adjustment signal indicating greater removal of humidity from the cooled air out, the logic may decrease the speed of the airflow across the evaporative units.

In many embodiments, an override temperature sensor located in proximity to the evaporative units will transmit an override signal to the logic and this override signal may be given a priority over the adjustment signal to increase the fan motor speed to avoid or attenuate freezing of parts of the evaporative units.

Upon determining the modification to the driving, the logic may transmit a signal to implement the modification to drive the fan motor at the new speed (element 1740). In some embodiments, adjusting the speed of the fan motor may involve increasing the alternating current or direct current amperage to the motor. In other embodiments, modifying the drive may involve shifting gears of a transmission or modifying the flow of fuel to the motor. In still other embodiments, modifying the driving of the fan motor may involve modifying the alternating current or direct current voltage driving the motor. In many embodiments, the logic may reside on or near the variable air unit while in other embodiments, the logic may reside in or near the A/C controller.

After modifying the driving, the logic may await or monitor for additional adjustments to the driving unless the fan motor is to be shut down (element 1750). In some embodiments, modifying the driving may comprise adjusting or amplifying the adjustment signal to transmit to a motor controller for the fan. In further embodiments, the logic may generate a new signal based upon the adjustment signal.

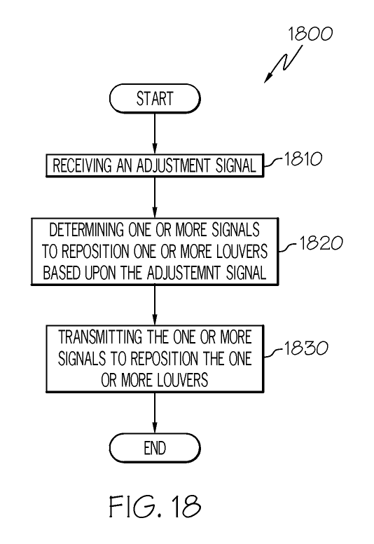

FIG. 18 illustrates an embodiment 1800 of a flow chart for a variable air unit comprising one or more louvers such as the louver arrangements in FIGS. 6-7. Embodiment 1800 begins with receiving an adjustment signal (element 1810). The adjustment signal may be a signal indicative of a temperature upon which to base control of the heat exchange between the refrigerant in the evaporative coils and the airflow across the coils or the humidity. In some embodiments, for example, a humidity sensor may generate the adjustment signal. The humidity sensor may couple with the warm air in, the cooled air out, or both. In further embodiments, the humidity sensor may be located on the A/C controller or otherwise located in the air-conditioned space.

Upon receiving the signal, logic may determine one or more signals to reposition one or more louvers based upon the adjustment signal to modify the positions of the one or more louvers (element 1820). For example, repositioning the one or more louvers may incrementally affect the amount of airflow across the coils and the amount of airflow that bypasses the coils. In such embodiments, the logic may open the bypass louver to increase the airflow of a bypass and decrease the airflow across the evaporative coils in response to an indication to increase humidity or temperature of the cooled or conditioned air. On the other hand, in response to an indication that ice is forming on the evaporative units, the bypass louver may be closed to reduce airflow through the bypass and increase airflow across the evaporative units. In many embodiments, the evaporative units are opposing direction, evaporative coils.

Upon determining the one or more signals to reposition the one or more louvers, the logic may transmit the one or more signals to the louvers or one or more motor controllers coupled with the louvers (element 1830). In several embodiments, transmitting the one or more signals may involve transmitting the one or more signals from controller logic in an A/C controller. In other embodiments, transmitting the one or more signals may involve transmitting the one or more signals from logic within or in the proximity of the indoor unit of an A/C system.

Another embodiment is implemented as a computer program product for implementing systems and methods described with reference to FIGS. 1-18. Embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet adapter cards are just a few of the currently available types of network adapters.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Alternately the control logic may be resident elsewhere and communicate with the A/C via Blue tooth or other of the many systems for remote control of appliances, garage doors, A/C etc.

Similarly a remote control, as are now commonly used with window A/C units, may be used to communicate with the A/C and the control logic could be placed in the remote device, in a controller of the A/C unit or partially in the remote device and partially in a controller of the A/C unit.

It will be apparent to those skilled in the art having the benefit of this disclosure that the present disclosure contemplates air-conditioning with dehumidification. It is understood that the form of the embodiments shown and described in the detailed description and the drawings are to be taken merely as examples. It is intended that the following claims be interpreted broadly to embrace all variations of the example embodiments disclosed.

Although the present disclosure has been described in detail for some embodiments, it should be understood that various changes, substitutions, and alterations can be made herein without departing from the spirit and scope of the disclosure as defined by the appended claims. Although specific embodiments may achieve multiple objectives, not every embodiment falling within the scope of the attached claims will achieve every objective. Moreover, the scope of the present application is not intended to be limited to the particular embodiments of the process, machine, manufacture, composition of matter, means, methods, and steps described in the specification. As one of ordinary skill in the art will readily appreciate from this disclosure, processes, machines, manufacture, compositions of matter, means, methods, or steps presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A heat exchange unit for an air-conditioning system, comprising:
tubes with projections to increase surface for exchange of thermal energy from a refrigerant inside the tubes to air passing outside the surfaces of the heat exchange device;
a distribution line coupled with the tubes at a first end to distribute the refrigerant to the tubes;
an inlet coupling coupled with the distribution line to receive the refrigerant;
a collection line coupled with the tubes at a second end to receive the refrigerant after the refrigerant passes through the tubes;
an outlet coupling coupled with the collection line to output the refrigerant; and
connections to couple the heat exchange unit with an incoming airflow and an outgoing airflow.

2. The heat exchange unit of claim 1, wherein heat exchange unit is designed to create airflow in a direction, which is substantially the opposite direction of the flow direction of the refrigerant based upon the difference in temperature between the refrigerant at the first end and the second end of the heat exchange unit.

3. The heat exchange unit of claim 3, wherein the tubes are physically designed to accommodate the airflow about ice while the ice accumulates on the tubes.

4. An indoor unit for an air-conditioning system, comprising:
a cabinet to receive an input airflow and to output a conditioned airflow, the cabinet comprising:
a hollow plate comprising an inlet coupling on one end of the hollow plate and an outlet coupling on an opposite end of the hollow plate, the inlet coupling to couple with an expansion valve to receive the refrigerant to flow within the hollow plate and the outlet coupling to couple with an outgoing line to return the refrigerant to a compressor after the refrigerant passes through the hollow plate; and
connections to couple the indoor unit with an incoming airflow and an outgoing airflow designed to create airflow in a direction that is substantially the opposite direction of the flow direction of the refrigerant in the hollow plate.

5. The indoor unit of claim 4, further comprising an expansion valve coupled with the inlet coupling of the hollow plate via a line.

6. An evaporator coil unit for an air-conditioning system, comprising:
a set of coils, each coil of the set comprising a medium to transport a refrigerant in one general direction from a first end of the coil to the second end of the coil, the first end of each coil being at a first end of the set of coils and the second end of each coil being at a second end of the set of coils, the medium to conduct heat from an outside the medium to the refrigerant;
an inlet coupling to receive the refrigerant;
an outlet coupling to output the refrigerant;
a first set of interconnections coupled with inlet and the set of coils at the first end of the set of coils to interconnect the first end of each of the coils with the inlet coupling; and
a second set of interconnections coupled with the outlet and the set of coils at the second end of the set of coils to interconnect the second end of each of the coils with the outlet coupling.

7. The evaporator coil of claim 6, wherein evaporator coil unit is designed to facilitate airflow in a second general direction, which is substantially opposite of the one general direction, from the second end of the set of coils to the first end of the set of coils.

8. The evaporator coil of claim 7, wherein the set of coils is physically designed to accommodate the airflow while ice accumulates on the medium.

9. A method comprising:
controlling a temperature of a refrigerant on the low pressure side of an expansion valve via the expansion valve to be close to the freezing temperature of water;
directing, via an evaporator coil, the refrigerant, which is a liquid which at close to the freezing temperature of water to cool, in a first general direction through an evaporator coil; and
directing an airflow across the coil in a second general direction, wherein the second general direction is substantially the opposite of the first general direction.

10. The method of claim 9, wherein directing an airflow across the coil comprises transferring heat from the air to the refrigerant via thermally conductive materials from which the coil is made, to reduce the airflow to less than 55 degrees Fahrenheit while crossing the coil.

11. The method of claim 9, wherein directing an airflow across the coil comprises transferring heat from the air to the refrigerant via thermally conductive materials from which the coil is made, to reduce the airflow to less than 45 degrees Fahrenheit while crossing the coil.

12. The method of claim 9, wherein directing an airflow across the coil comprises transferring heat from the air to the refrigerant via thermally conductive materials from which the coil is made, to reduce the airflow to approximately 32 degrees Fahrenheit while crossing the coil.

13. The method of claim 9, wherein directing an airflow across the coil comprises transferring heat from the air to the refrigerant via thermally conductive materials from which the coil is made, to reduce the airflow to approximately 32 degrees Fahrenheit while crossing the coil and directing the airflow about ice buildup on the coil.

14. The method of claim 9, wherein directing airflow comprises directing airflow through a second medium about the coil.

15. The method of claim 9, wherein directing airflow through a second medium about the coil comprises directing airflow through media, wherein each medium of the media encompasses at least one coil of a set of coils.

16. A method for retrofitting a standard air conditioner with opposing direction evaporative coils to cool and dehumidify airflow, the method comprising:
adjusting the direction of flow of a refrigerant through the evaporative coils to flow in a first direction that is substantially opposite to the flow direction of the airflow about the evaporative coils;
coupling a thermostat to a return line of the refrigerant, the return line being a low-pressure line between the evaporator coils and a compressor; and
coupling the thermostat to a variable airflow controller to determine adjustments for a rate of airflow across the evaporative coils; and
coupling the variable airflow controller with an airflow unit to adjust the rate of airflow across the evaporative coils.

17. The method of claim 16, wherein adjusting the direction of flow comprises replacement of existing evaporative coils of the standard air conditioner with an opposing direction, evaporative unit.

18. The method of claim 16, wherein adjusting the direction of flow comprises adding an opposing direction, evaporative unit to existing evaporative coils of the standard air conditioner.

19. The method of claim 16, wherein adjusting the direction of flow comprises modifying existing evaporative coils of the standard air conditioner to form opposing direction, evaporative coils and installing the opposing direction, evaporative coils to direct the refrigerant in a substantially opposite direction through the coils than the airflow across the coils.

20. An air-conditioning system with dehumidification, comprising:
a compressor to compress a refrigerant;
a condenser coil to couple with the compressor to receive the refrigerant from the compressor and output the refrigerant in a condensed form;
a device to couple with the condenser coil to reduce the pressure of the refrigerant from the condenser coil to a pressure at which a temperature of the refrigerant is close to 32 degrees Fahrenheit; and
an evaporator unit to couple with the device to receive the refrigerant, the evaporator unit to direct the refrigerant from a first side of the unit to a second side of the unit and direct airflow from the second side of the unit to the first side of the unit, wherein the refrigerant is to be at a first low temperature upon entering the first end of the unit and a first high temperature at the second end of the unit and the airflow is to be at a second high temperature at the second end of the unit and a second low temperature at the first end of the unit by conducting heat to the refrigerant prior to exiting into a conditioned space.

21. The air-conditioning system of claim 20, further comprising a variable speed fan to vary the speed of the airflow through the evaporator unit based on the temperature of the refrigerant as it leaves the evaporator unit and returns to the compressor, or based on the temperature of the cooled air leaving the unit.

22. The air-conditioning system of claim 21 further comprising an override temperature sensor which speeds up the air flow if the coldest part of the coil freezes.

27. The air-conditioning system of claim 20, wherein the variable speed fan comprises a direct current (DC) motor and circuitry coupled with the DC motor to vary the speed of rotation of the motor.

23. The air-conditioning system of claim 20, wherein the variable speed fan comprises an alternating current (AC) motor and circuitry coupled with the AC motor to vary the speed of rotation of the motor or where louvers vary the volume of airflow.

24. The air-conditioning system of claim 20, wherein the compressor comprises a variable speed compressor.

25. The air-conditioning system of claim 20, further comprising a controller to adjust the speed of airflow by adjusting the speed of rotation of the variable speed fan.

26. The air-conditioning system of claim 20, further comprising a controller to adjust the speed of airflow by adjusting the speed of rotation of the variable speed fan.

27. The air-conditioning system of claim 20, wherein a refrigeration cycle of the air-conditioning system is designed to reduce the temperature of the airflow to approximately 34-40 degrees Fahrenheit upon exiting the evaporator unit.

28. The air-conditioning system of claim 20, wherein a refrigeration cycle of the air-conditioning system is designed to reduce the temperature of the airflow to less than 55 degrees Fahrenheit upon to exiting the evaporator unit.

29. The air-conditioning system of claim 20, wherein a controller of the air-conditioning system is designed to adjust the airflow based upon a humidity setting, where a higher air flow at the same temperature in the conditioned air space creates higher humidity and vice versa.

30. The air-conditioning system of claim 29, wherein the compressor speed or on/off setting is calculated from a combination of wet bulb and dry bulb temperature.

31. The air-conditioning system of claim 20, further comprising a controller to adjust the speed of airflow by adjusting a position of one or more louvers.

32. The air-conditioning system of claim 20, wherein the evaporator unit comprises at least one hollow plate, the hollow plate to direct refrigerant to accomplish an opposing direction, heat exchange between the airflow and the refrigerant.

33. The air-conditioning system of claim 20, wherein the evaporator unit comprises at least two tubes with projections, each tube to direct refrigerant to accomplish an opposing direction, heat exchange between the airflow and the refrigerant.

34. The air-conditioning system of claim 20, wherein the evaporator unit comprises at least two sets of coils, each set of coils to direct airflow to accomplish an opposing direction, heat exchange between the airflow and the refrigerant.

35. The air-conditioning system of claim 32, further comprising a controller to adjust the adjust positions of one or more louvers to direct airflow across the at least two sets of coils in parallel for higher humidity or in series for lower humidity

36. The air-conditioning system of claim 20, further comprising a controller to adjust the positions of one or more louvers to direct at least part of the airflow through a path to bypass the coils of the evaporator unit to achieve low temperature/humidity in the air passing through the coils.

37. A retrofitted evaporative unit for an air-conditioning system comprising:
an opposing direction, evaporative unit and
a second coil coupled in series with the opposing direction, evaporative unit to compressor to compress a refrigerant.

38. The retrofitted evaporative unit of claim 37, wherein opposing direction, evaporative unit is coupled on the incoming air side of the second coil to condition the incoming air before the incoming air passes through the second coil.

39. The retrofitted evaporative unit of claim 37, wherein opposing direction, evaporative unit is coupled on the outgoing air side of the second coil to condition the incoming air after the incoming air passes through the second coil.

40. The retrofitted evaporative unit of claim 37, further comprising one or more louvers to adjust the amount of airflow through one or both of the coils.

41. The retrofitted air-conditioning system comprising:
a compressor to compress a refrigerant;
a condenser coil to couple with the compressor to receive the refrigerant from the compressor and output the refrigerant in a condensed form; and
an evaporative unit comprising an opposing direction, evaporative unit and a second coil coupled in series with the opposing direction, evaporative unit to compressor to compress a refrigerant.

42. The retrofitted air-conditioning system of claim 41, wherein opposing direction, evaporative unit is coupled on the incoming air side of the second coil to condition the incoming air before the incoming air passes through the second coil.

43. The retrofitted air-conditioning system of claim 41, wherein opposing direction, evaporative unit is coupled on the outgoing air side of the second coil to condition the incoming air after the incoming air passes through the second coil.

44. The retrofitted air-conditioning system of claim 41, further comprising one or more louvers to adjust the amount of airflow through one or both of the coils.
